(19) United States
(12) Patent Application Publication
(10) Pub. No.: US 2026/0037921 A1
(43) Pub. Date: Feb. 5, 2026

(54) INFORMATION PROCESSING APPARATUS, INFORMATION PROCESSING METHOD, INFORMATION PROCESSING SYSTEM, AND NON-TRANSITORY COMPUTER READABLE MEDIUM

(71) Applicant: KABUSHIKI KAISHA TOSHIBA, Tokyo (JP)

(72) Inventors: Kanau Kumekawa, Kawasaki Kanagawa (JP); Shizu Sakakibara, Kawasaki Kanagawa (JP); Takufumi Yoshida, Funabashi Chiba (JP)

(73) Assignee: KABUSHIKI KAISHA TOSHIBA, Tokyo (JP)

(21) Appl. No.: 19/269,138

(22) Filed: Jul. 15, 2025

(30) Foreign Application Priority Data
Jul. 30, 2024 (JP) 2024-123760

(51) Int. Cl. G06Q 10/087; B65G 1/04

(52) U.S. Cl. CPC G06Q 10/08724; B65G 1/04

(57) ABSTRACT

An information processing apparatus includes a processor configured to manage shelf movement in a keeping region composed of multiple adjacent unit regions, each capable of holding a shelf. The processor acquires information on target shelves and their respective destination regions, and divides the target shelves into groups. For each group, it determines an exclusive region including the current position of the target shelf, its destination, and an adjacent empty region. Based on this, the processor generates a movement plan in which other shelves within the exclusive region are moved to relocate the empty region, enabling the target shelf to reach its destination.

### CROSS REFERENCE TO RELATED APPLICATIONS

This application is based upon and claims the benefit of priority from the prior Japanese Patent Application No. 2024-123760, filed on Jul. 30, 2024, the entire contents of which are incorporated herein by reference.

### FIELD

Embodiments described herein relates to an information processing apparatus, an information processing method, an information processing system, and a non-transitory computer readable medium.

### BACKGROUND

The range of use has been expanded of mobile objects such as automatic guided vehicles (AGVs), autonomous mobile robots, automatic travel vehicles, and construction machines. A plurality of shelves are arranged in a region for keeping articles (keeping region), and articles or containers containing the articles are kept on the shelves. When an article is to be taken out, a shelf is moved to a desired position by a mobile object. The desired position may be, for example, a position outside the keeping region, a position inside the keeping region and facing an external passage, or the like. To keep more articles in a limited area of the keeping region, the number of passages or the like in the keeping region is reduced to densely arrange shelves in some cases.

When the shelves are densely arranged, there may be a shelf surrounded by other shelves. In that case, moving a shelf adjacent to the surrounded shelf to form an empty region and moving the surrounded shelf to the empty region can be repeated to move the shelf to a desired position.

However, when moving a plurality of shelves, moving the shelves in order takes time. In particular, shelves of later orders are kept long on standby. When a plurality of shelves are to be moved simultaneously, it is necessary to control timing of movement of the shelves while considering movement states of the shelves, resulting in complicated control. Movement paths may be also complicated, and movement may take more time.

### BRIEF DESCRIPTION OF THE DRAWINGS

FIG. 1 shows an example of an operation plan system according to a first embodiment;

FIG. 2 is a schematic diagram of a keeping region in plan view;

FIG. 3 shows an example of data stored in a carry-out instruction storage;

FIG. 4 shows an example of data stored in a shelf arrangement storage;

FIG. 5 shows an example of data stored in a mobile object arrangement storage;

FIG. 6 shows an example of data stored in a mobile object operation storage;

FIG. 7 shows an example of data stored in a keeping region arrangement storage;

FIG. 8 is a flowchart of an example of an operation of a plan processor;

FIG. 9 shows an example of a carry-out group setter dividing a plurality of target shelves into a plurality of carry-out groups and setting an exclusive region for each carry-out group;

FIG. 10 shows another example of integration of a plurality of use regions;

FIG. 11 shows an example of generation of a shelf movement plan;

FIG. 12 shows an example of generation of an operation plan for a mobile object;

FIG. 13 shows an example of generation of a shelf movement plan to join two target shelves partway;

FIG. 14 shows an example of integration of two carry-out groups;

FIG. 15 shows an example of a mobile object being commonly assigned to a plurality of carry-out groups;

FIG. 16 shows an example of a mobile object and a blank cell being commonly assigned to a plurality of carry-out groups;

FIG. 17 shows an example of a mobile object in a different keeping region being used in a keeping region;

FIG. 18 shows an example of a mobile object and a blank cell in a different keeping region being used in a keeping region;

FIG. 19 shows an example of a plurality of mobile objects being assigned to one carry-out group;

FIG. 20 is a block diagram of an operation plan system according to a fourth embodiment;

FIG. 21 is a flowchart of an example of an operation of a plan processor in FIG. 20;

FIG. 22 illustrates an example of generation of a blank cell movement plan;

FIG. 23 is a block diagram of an operation plan system according to a fifth embodiment;

FIG. 24 is a flowchart of an example of an operation of a plan processor in FIG. 23;

FIG. 25 shows an example of a target shelf being moved out of the exclusive region in the carry-out group to again perform a process of setting a carry-out group; and

FIG. 26 shows a hardware configuration of an operation plan apparatus according to any one of first to fifth embodiments.

### DETAILED DESCRIPTION

An information processing apparatus comprising a processor, the processor being configured to,
read
   information on a keeping region, the keeping region including a plurality of unit regions adjacent to each other, a shelf being able to be arranged in each of the unit regions, the shelf arranged in the unit region being movable to an empty region that is a unit region adjacent to the unit region and in which no shelf is arranged,
   information on a plurality of target shelves among the plurality of the shelves arranged in any of the unit regions in the keeping region, and
   information on a plurality of target regions that are the unit regions as destinations of the plurality of target shelves, divide the plurality of target shelves into a plurality of groups each including one or more of the target shelves,
determine, for each of the groups, an exclusive region exclusively usable and including unit regions adjacent to each other, the exclusive region including the unit region in which the target shelf is arranged, the target region of the target shelf, and the empty region, and
generate, for each of the groups, a first shelf movement plan to move a shelf different from the target shelf in the exclusive region to change a position of the empty region, thereby moving the target shelf to the target region.

Now, embodiments will be described with reference to the drawings. Although the following description focuses on main components of the embodiments, components and functions that are not shown or described may be present. The following description does not exclude components and functions that are not shown or described.

### First Embodiment

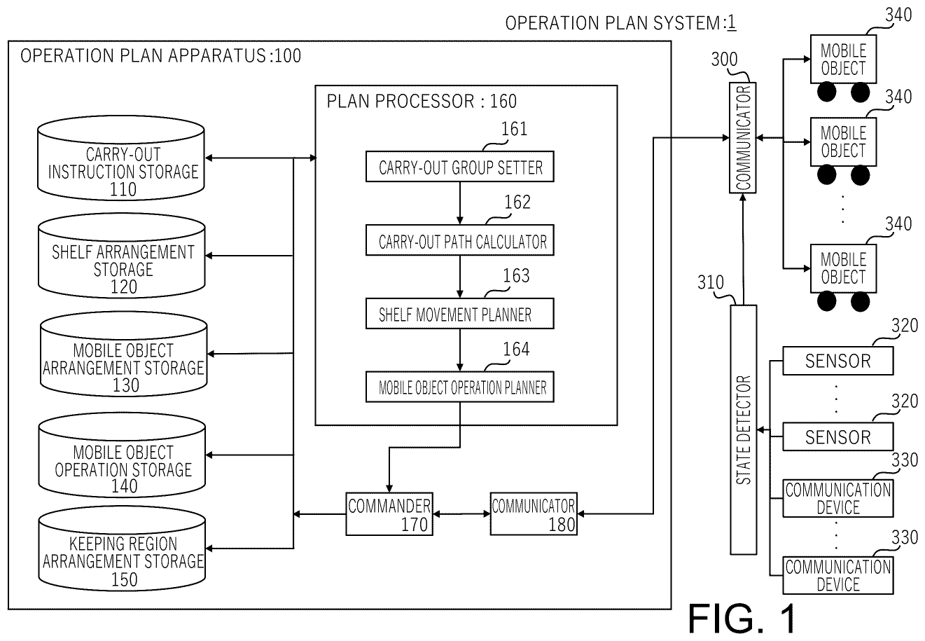

FIG. 1 shows an example of an operation plan system 1 as an information processing system according to a first embodiment. The operation plan system 1 includes an operation plan apparatus 100 that is an information processing apparatus according to the first embodiment, a communicator 300, a state detector 310, a plurality of sensors 320, a plurality of communication devices 330, and a plurality of mobile objects 340.

The mobile object 340 is movable in a keeping region of an article. The mobile object 340 may be moved out of the keeping region and movable in an outside region. A plurality of shelves are arranged in the keeping region, and can accommodate articles or containers containing the articles. The keeping region is provided, for example, in a factory, a warehouse, a facility site, or the like. The mobile object 340 is, for example, an automatic guided vehicle (AGV), a mobile robot, or an automatic travel vehicle (for example, an autonomous vehicle). The mobile object 340 is not limited to one moving on the ground, but may be one moving in the air such as a drone.

The mobile object 340 performs various operations in accordance with control instructions from a commander 170 described later. The various operations include an operation of moving (including a change in direction in a stop position), an operation of lifting up and down a shelf, and an operation of moving while lifting up the shelf. The operation of lifting up the shelf is an example of an operation of the mobile object holding the shelf to move the shelf. The operation of lifting down the shelf is an example of an operation of releasing the shelf. Examples of other operations of holding and releasing the shelf may include an operation of coupling to or decoupling from the shelf using a magnet or a mechanical mechanism to push or pull the shelf. The mobile object 340 includes a battery as an example, and operates with power accumulated in the battery. The operation of lifting up and down the shelf will be described below as the operation of holding and releasing the shelf, but such an operation is merely an example, and the present embodiment is not limited to this.

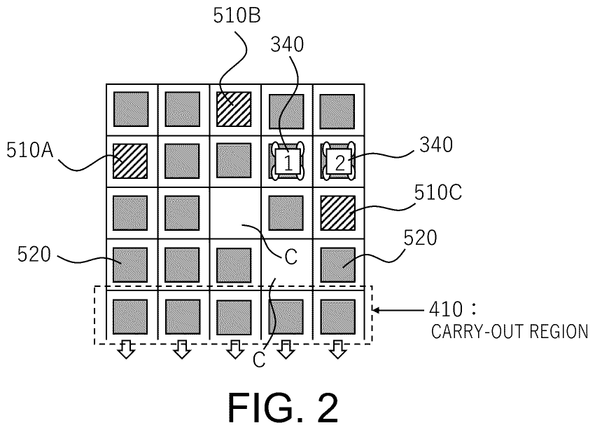

FIG. 2 is a schematic diagram of a keeping region in plan view. The keeping region includes a plurality of cells (unit regions) adjacent to each other. The plurality of unit regions are arranged in a grid of two rows and two columns or more. One shelf can be arranged in each unit region, and there is an empty region (blank cell) C that is a unit region in which no shelf is arranged. Shelves 510A to 510C and 520 are arranged in the keeping region. Two mobile objects 340 are also arranged in the keeping region. The two mobile objects 340 include a mobile object 1 having a mobile object ID of 1 and a mobile object 2 having a mobile object ID of 2. In the drawings, lines marking off the cells are virtual, and do not hinder the mobile objects from moving between the cells (including both movement of the mobile object while lifting up the shelf and movement of the mobile object without holding the shelf). The shelf arranged in the unit region (cell) can be moved to an empty region (blank cell) adjacent to the unit region by the mobile object.

The unit regions (cells) include a unit region (cell) in which a shelf is arranged, and an empty region C (blank cell C) in which no shelf is arranged. In this example, there are two blank cells C. The shelves are shown by solid squares or hatched squares. The hatched square shelves 510A, 510B, 510C are shelves (target shelves) to be moved by the mobile objects 340 to a carry-out region 410 including cells in a bottom row in the keeping region. In this example, the carry-out region 410 includes five cells in one row, and these five cells are unit regions that can be designated as destinations of the target shelves. The unit region designated as a destination of a target shelf is referred to as a target region (target cell). The solid shelves 520 are shelves other than the target shelves (sometimes also referred to as different shelves).

A space (not shown) through which the mobile object 340 can pass is provided between a bottom surface (surface facing the keeping region) of each shelf and a floor of the keeping region. The mobile object 340 can move between the cells in which the shelves are arranged through the space under the shelves. The mobile object can move between the cells in vertical and lateral directions in the plane of the drawings, and does not move in an oblique direction. In the drawings, the mobile object is shown on the shelf for visibility, but the mobile object is actually located under the shelf.

The mobile object can lift up the shelf in a direction opposite to gravity using a mechanism (not shown) in the space under the shelf. The mobile object thus holds the shelf. The mobile object can move to a next blank cell C while lifting up the shelf. When not lifting up the shelf, the mobile object can move between the cells in which the shelves are arranged through the space under the shelves. If a passage is provided between the shelves in accordance with a structure of the keeping region, the mobile object may move through the passage.

The shelf located in any cell (target region) in the carry-out region 410 may be lifted up by the mobile object and carried out of the keeping region in a direction shown by open arrows. The carried-out shelf may be moved by the mobile object to a predetermined position (location), for example, a location of a user. The user may pick up a target article or container from the shelf in that location. Alternatively, when the shelf is moved to any cell (target region) in the carry-out region 410, the shelf is lifted down in that position, and the user may pick up an article or the like from the shelf. In this case, the shelf does not need to be carried from the carry-out region 410 out of the keeping region. In the following description, the case is assumed where the shelf is carried at least to the carry-out region 410.

The communicator 300 is arranged in at least one of the keeping region and the outside of the keeping region, and relays communication between the mobile object 340 and the operation plan apparatus 100. The communicator 300 can communicate with a communicator 180 of the operation plan apparatus 100. The communicator 300 can communicate with the mobile object 340 and the state detector 310. These communications may be wired or wireless. The communicator 300 receives, from the operation plan apparatus 100, a control instruction to the mobile object 340, and transmits the control instruction to the mobile object 340. This causes the mobile object 340 to operate in accordance with an operation plan generated by the operation plan apparatus 100.

The sensor 320 is arranged in at least one of the keeping region and the outside of the keeping region, and detects a state of the mobile object 340 passing through a sensing range. For example, the sensor 320 may detect a position and a speed, or the like of the mobile object 340, or detect an operation of the mobile object 340 (for example, whether or not the mobile object 340 is holding a shelf, whether or not the mobile object 340 is immovable due to a fall, or the like).

The communication device 330 is arranged in at least one of the keeping region and the outside of the keeping region, and communicates with the mobile object 340 by a communication scheme different from that of the communicator 300. For example, the communicator 300 may communicate by wireless LAN, and the communication device 330 may communicate by Bluetooth low energy (BLE). With the communication device 330, information on the state of the mobile object 340 can be obtained even when the mobile object 340 is located in a region where it cannot communicate with the communicator 300. The communication device 330 may obtain, from the mobile object 340, for example, information of the same kind as one detected by the sensor 320. This allows information on the state of the mobile object 340 to be obtained even when there is a mobile object 340 that does not pass through the sensing range of the sensor 320.

The state detector 310 obtains, from the sensor 320 and the communication device 330, the information on the state of the mobile object 340, and transmits the obtained information to the communicator 300. The communicator 300 obtains, from the state detector 310, the information on the state of the mobile object 340, and transmits the obtained information to the operation plan apparatus 100.

The operation plan apparatus 100 includes storages 110 to 150, a plan processor 160, the commander 170, and the communicator 180. The operation plan apparatus 100 may include an input device configured to input information to the storages 110 to 150. The input device may obtain information input by a user using a keyboard, a mouse, a touch panel, a voice input device, or the like, and store the information in the storages 110 to 150.

The carry-out instruction storage 110 stores data on a shelf carry-out instruction. The shelf carry-out instruction includes either an instruction to move a shelf to any cell (target region) in the carry-out region 410 or an instruction to move the shelf from the carry-out region 410 to a predetermined position (for example, a position of a user who picks up an article) outside the keeping region. The cell in the carry-out region 410 corresponds to a target region (target cell) that is a unit region as a destination of the shelf instructed to be carried out.

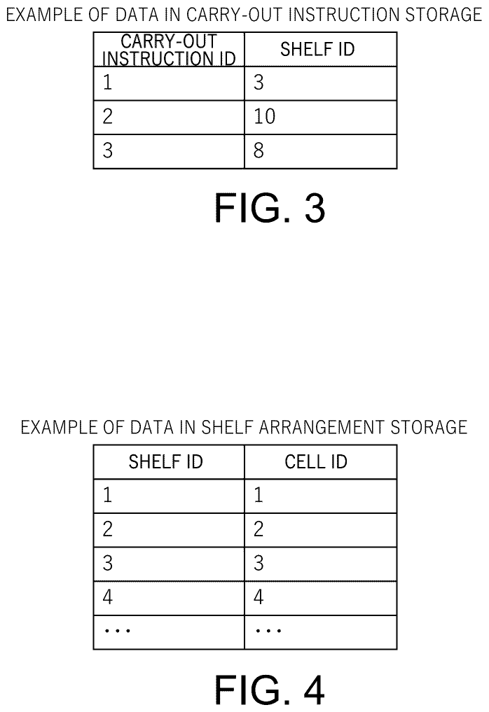

FIG. 3 shows an example of data stored in the carry-out instruction storage 110. Three carry-out instructions are stored, and shelves (target shelves) to be carried out are shelves having shelf IDs of 3, 10, 8. A shelf having a shelf ID of X is denoted as a shelf X. One carry-out instruction designates one shelf. One carry-out instruction may designate a plurality of shelves. The data stored in the carry-out instruction storage 110 includes information on the plurality of target shelves among a plurality of shelves arranged in any cells (unit regions) in the keeping region.

The shelf arrangement storage 120 stores data on a position of a shelf arranged in the keeping region.

FIG. 4 shows an example of data stored in the shelf arrangement storage 120. The shelf arrangement storage 120 stores shelf IDs, and cell IDs that identify cells in which shelves identified by the shelf IDs are arranged. The cell ID is an ID identifying a cell in the keeping region. A cell having a cell ID of Y is denoted as a cell Y. Correspondence between the cell ID and a position of the cell (x coordinate and y coordinate) is defined by data stored in the keeping region arrangement storage 150 described later.

The mobile object arrangement storage 130 stores data on a position of a mobile object (initial position of the mobile object).

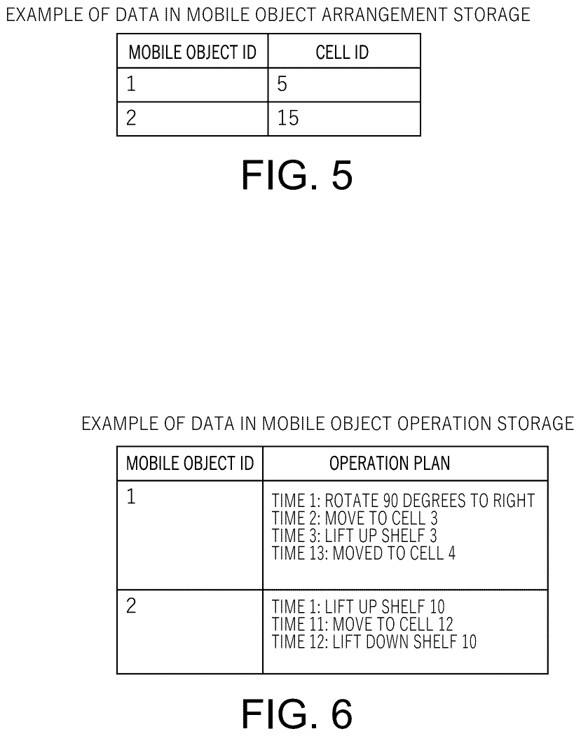

FIG. 5 shows an example of data stored in the mobile object arrangement storage 130. The mobile object arrangement storage 130 stores mobile object IDs and cell IDs. A mobile object having a mobile object ID of Z is denoted as a mobile object Z. For example, a mobile object 1 is arranged in a cell 5 at first (that is, at time of planning). When the mobile object is located outside the keeping region, an ID according to its position may be defined.

The mobile object operation storage 140 stores data on an operation plan for a mobile object generated by the plan processor 160. The data does not need to be stored at first (at start of planning).

FIG. 6 shows an example of data stored in the mobile object operation storage 140. The mobile object operation storage 140 stores mobile object IDs, and operation plans for mobile objects identified by the mobile object IDs. Each operation plan is determined by contents of an operation of the mobile object, a cell in which the operation is performed, and a start time of the operation. In this example, the operation plan shows that the mobile object 1 rotates 90 degrees to the right at time 1, starts moving to a cell 3 at time 2, lifts up a shelf 3 in the cell 3 at time 3, and starts moving from the cell 3 to a cell 4 while lifting up the shelf 3 at time 13. Information on the mobile object (for example, information on specifications) such as a speed of the mobile object, time required to change in direction, time required to lift up and down the shelf is previously determined for each mobile object. All the mobile objects may commonly have such specifications, or the mobile objects may have different specifications. The information on the mobile objects may be stored in the mobile object arrangement storage 130 or a different storage.

The keeping region arrangement storage 150 stores data on a position of each cell (x and y coordinates) in the keeping region and whether or not each cell is in the carry-out region 410.

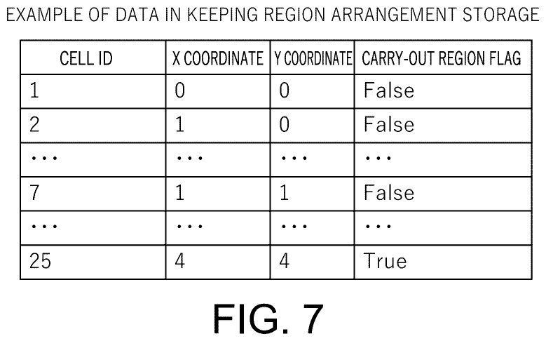

FIG. 7 shows an example of data stored in the keeping region arrangement storage 150. The keeping region arrangement storage 150 stores cell IDs, x coordinates, y coordinates, and carry-out region flags. For example, when the keeping region is a grid-like region including cells in five rows and five columns and includes 25 cells in total, there are cell IDs of 1 to 25. For example, when the x coordinate and the y coordinate of the top left cell are both zero, and a distance to each adjacent cell is 1, there are 25 x coordinates and y coordinates of (0,0) to (4,4). When the cell is in the carry-out region 410, the carry-out region flag is “True”, and when the cell is not in the carry-out region 410, the carry-out region flag is “False”. The data stored in the keeping region arrangement storage 150 includes information on the keeping region, and information on the plurality of target regions that are the unit regions as destinations of the plurality of target shelves.

The plan processor 160 generates the operation plan for the mobile object (see FIG. 6) to move a target shelf designated by the data in the carry-out instruction storage 110 to the carry-out region 410, or move the target shelf through the carry-out region 410 to a predetermined position. The plan processor 160 will be described later in detail.

The communicator 180 communicates with the communicator 300 provided in at least one of the keeping region and the outside of the keeping region.

The commander 170 is a controller configured to control the mobile object 340 to implement the operation plan for the mobile object 340 generated by the plan processor 160. The commander 170 reads, from the mobile object operation storage 140, the data on the operation plan for the mobile object 340, and generates a control instruction to control the operation of the mobile object 340 based on the read data. The commander 170 transmits the generated control instruction to the mobile object 340. This controls the operation of the mobile object 340.

The plan processor 160 includes a carry-out group setter 161, a carry-out path calculator 162, a shelf movement planner 163, and a mobile object operation planner 164.

First, an outline of an operation of the plan processor 160 will be described. The plan processor 160 divides a plurality of target shelves into a plurality of groups (hereinafter referred to as carry-out groups). Each carry-out group includes one or more target shelves. For each carry-out group, a region that can be exclusively used (exclusive region) to move a target shelf to the carry-out region 410 is set so as not to overlap an exclusive region in a different carry-out group. The exclusive region includes a plurality of cells (unit regions) adjacent to each other that can be exclusively used, and includes, as an example, a unit region in which a target shelf is arranged, a target region of the target shelf, and at least one empty region (blank cell).

The plan processor 160 calculates or determines, independently for each carry-out group, a path (hereinafter referred to as a carry-out path) along which the target shelf is moved to the carry-out region 410 in the exclusive region. The plan processor 160 generates a movement plan for a shelf (hereinafter referred to as a shelf movement plan) to move the target shelf along the carry-out path in the exclusive region.

The shelf movement plan includes repeating moving a different shelf in the exclusive region in a movement direction of the target shelf along the carry-out path so as to form a blank cell adjacent to a cell including the target shelf, and moving the target shelf to the formed blank cell, until the target shelf reaches the carry-out region 410.

This plan corresponds to a first shelf movement plan to move a shelf different from the target shelf in the exclusive region and move the target shelf to the carry-out region 410 (target region) while changing the position of the empty region in the exclusive region.

In the shelf movement plan, the movement of the shelf required to move the target shelf to the carry-out region 410 is performed only in the exclusive region in the carry-out group, and the shelf in the exclusive region is not moved out of the exclusive region.

A plan may be also generated such that when there is no blank cell in the exclusive region in each carry-out group, a different shelf in the exclusive region is first moved out of the exclusive region to ensure a blank cell in the exclusive region.

The plan processor 160 plans, for each carry-out group, an operation of the mobile object to move shelves (a target shelf and a different shelf) in accordance with the generated shelf movement plan to generate an operation plan for the mobile object. The commander 170 causes the operation plan for the mobile object to be implemented for each carry-out group, thereby allowing the plurality of target shelves to be moved in parallel to the carry-out region 410 efficiently or in a short time.

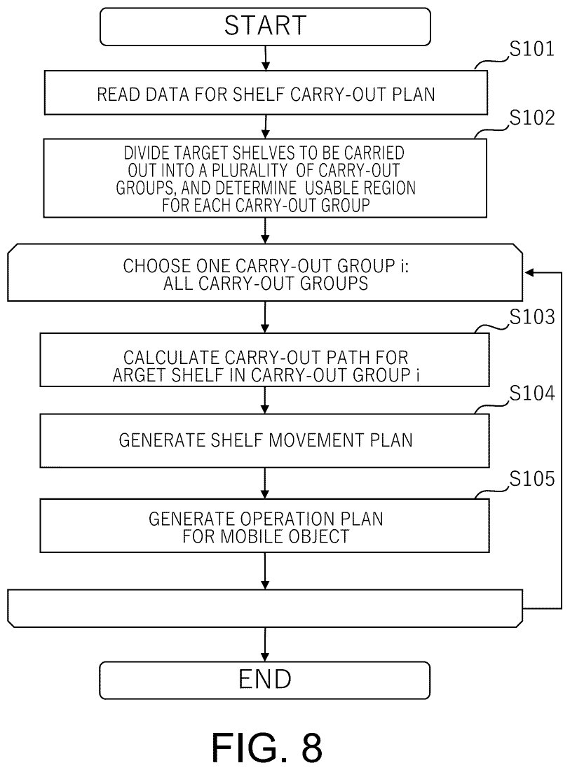

Hereinafter, with reference to FIG. 8, the operation of the plan processor 160 will be described.

FIG. 8 is a flowchart of an example of the operation of the plan processor 160. The flow of this operation corresponds to a flow of an information processing method according to the present embodiment.

First in step S101, the plan processor 160 obtains information on target shelves from the carry-out instruction storage 110, and obtains correspondence data between each shelf and each cell from the shelf arrangement storage 120. The plan processor 160 also obtains information on a usable mobile object from the mobile object arrangement storage 130, and obtains information on a keeping region from the keeping region arrangement storage 150.

In step S102, the carry-out group setter 161 divides a plurality of target shelves into a plurality of groups (carry-out groups) based on the information obtained in step S101, and sets a region exclusively used by each carry-out group (exclusive region). The exclusive region is separated from (that is, does not overlap) an exclusive region in a different carry-out group, and movement of shelves in the exclusive region does not affect movement of shelves in the exclusive region in the different carry-out group (the movements do not interfere with each other). A method of setting the carry-out groups will be described below in detail.

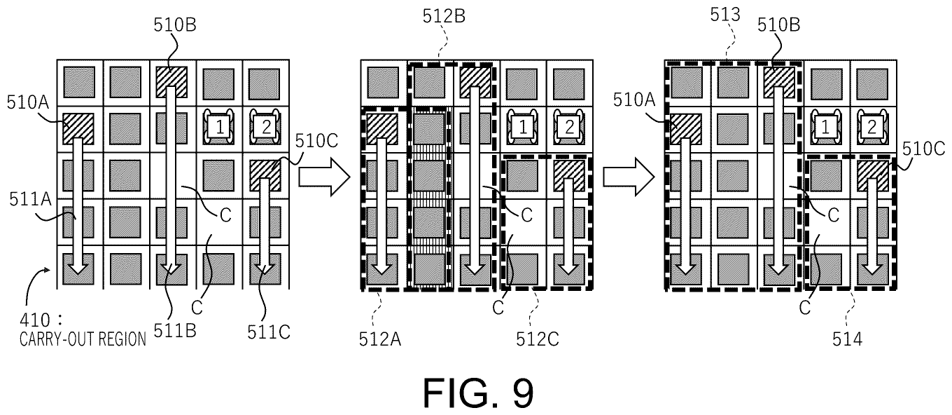

FIG. 9 shows an example of the carry-out group setter 161 dividing the plurality of target shelves into the plurality of carry-out groups and setting the exclusive region for each carry-out group.

First, a path (carry-out path) along which the target shelf is moved to the carry-out region 410 is determined. The carry-out path corresponds to a first path along which the target shelf is moved to the carry-out region 410 (target region) in the keeping region. The first path is a sequence of one or more cells (unit regions). On the left in FIG. 9, an example is shown in which shortest paths for target shelves 510A, 510B, 510C along which the target shelves can be moved to the carry-out region 410 in a shortest distance are calculated by a Dijkstra's algorithm or the like to set the paths as carry-out paths 511A, 511B, 511C.

To move each target shelf along each carry-out path, forming a blank cell in the movement direction of the target shelf and moving the target shelf to the blank cell need to be repeated. Then, a region (region that requires movement of the shelf) is calculated that needs to be used to form the blank cell in the movement direction of the target shelf and move the target shelf. The calculated region is referred to as a use region. The use region includes, for example, cells having a lateral width of two cells along the movement direction of the carry-out path for the target shelf. This is because a different shelf in a travel direction (forward direction) of the target shelf needs to be moved to a next column. On the middle in FIG. 9, an example is shown of use regions 512A, 512B, 512C being calculated for the target shelves 510A, 510B, 510C, respectively.

Two or more target shelves in the use regions that at least partially overlap each other are classified into the same carry-out group. The target shelves in the use regions that do not overlap each other at all are classified into different carry-out groups. An exclusive region is set so as to include all the use regions for one or more target shelves in the carry-out group. On the right in FIG. 9, an example is shown of the target shelves 510A, 510B being classified into the same carry-out group because the use regions 512A, 512B overlap each other and setting an exclusive region 513 including the use regions 512A, 512B. Since the use region 512C does not overlap either of the use regions 512A, 512B, the use region 512C is used alone as an exclusive region 514.

The method for forming the carry-out groups is not limited to this. For example, cost for carrying out the target shelves may be roughly calculated, and the target shelves may be grouped so as to minimize the cost. For example, the target shelves may be grouped so as to reduce a maximum time required to move all the target shelves in the plurality of carry-out groups to the target region.

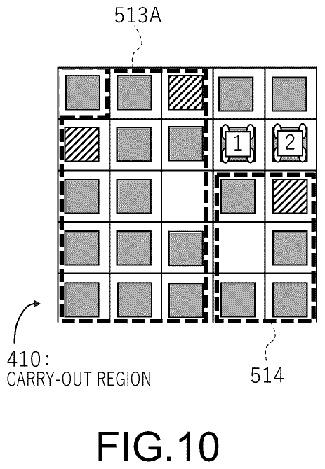

In FIG. 9, the exclusive region 513 includes a top left cell in addition to the combined use regions 512A, 512B, but does not need to include this cell. Such an example will be shown with reference to FIG. 10.

FIG. 10 shows another example of integration of the use regions 512A, 512B on the middle in FIG. 9. An exclusive region 513A is smaller by one cell than the combined use regions 512A, 512B.

The carry-out group setter 161 assigns one or more mobile objects and one or more blank cells to each carry-out group. On the right in FIG. 9, there are two carry-out groups, and one mobile object and one blank cell are assigned to each of the carry-out groups. More specifically, the mobile object 1 is assigned to the carry-out group including the shelves 510A and 510B, and the mobile object 2 is assigned to the carry-out group including the shelf 510C. The exclusive region in each carry-out group includes one blank cell C, and the blank cell C is directly assigned to each carry-out group. If the exclusive region in the carry-out group does not include the blank cell C, a blank cell outside the exclusive region may be assigned to the carry-out group. The blank cell outside the exclusive region is, for example, a blank cell that does not belong to any carry-out group or a blank cell that belongs to a carry-out group including excessive blank cells.

Assigning a blank cell means confirming that there is at least a blank cell in the exclusive region. Alternatively, if there is no blank cell, assigning a blank cell means confirming that a shelf other than a target shelf in the exclusive region can be moved to an outside region to form (ensure) a blank cell C in the exclusive region. Assigning a mobile object means ensuring a mobile object exclusively usable in the exclusive region.

When the number of mobile objects is larger than the number of carry-out groups, two or more mobile objects may be assigned to one carry-out group. In this case, for example, more mobile objects may be assigned to carry-out groups including more target shelves. Similarly, when the number of blank cells is larger than the number of carry-out groups, two or more blank cells may be assigned to part of the carry-out groups. In this case, for example, more blank cells may be assigned to carry-out groups including more target shelves. The target shelves may be grouped and at least either the mobile object or the blank cell may be assigned so as to reduce a maximum time required to move all the target shelves in the plurality of carry-out groups to the target region.

In step S103, the carry-out path calculator 162 calculates a carry-out path for the target shelf for each carry-out group. The carry-out path for the target shelf is a path through which the target shelf is moved to the carry-out region 410 included in the exclusive region in the carry-out group. The carry-out path for the target shelf corresponds to a second path through which the target shelf is moved to the target region in the exclusive region for each group. The second path is a sequence of one or more cells (unit regions). Any path may be calculated as long as only cells in the exclusive region in the carry-out group are used. For example, a path to the carry-out region 410 calculated when the carry-out group is set, for example, a shortest path calculated by a Dijkstra's algorithm may be directly used, or a path may be calculated by any other methods. When the carry-out paths for the plurality of target shelves overlap each other in the carry-out group, the carry-out paths may be changed so as not to overlap each other, or an order of target shelves to be carried out may be determined. When the order of the target shelves to be carried out is determined, an order of decreasing priority of the target shelves or an order of increasing distance to the carry-out region 410 may be used.

In step S104, the shelf movement planner 163 generates a shelf movement plan (first shelf movement plan) such that the target shelf can be moved to the carry-out region 410 along the carry-out path generated by the carry-out path calculator 162. The shelf movement plan includes repeating moving a different shelf in the movement direction of the target shelf along the carry-out path so as to form a blank cell adjacent to a cell including the target shelf, and moving the target shelf to the blank cell, until the target shelf reaches the carry-out region 410. The plan to move a different shelf so as to form a blank cell adjacent to a cell including the target shelf may include a plan to change a position of a cell in which a blank cell is to be formed (movement plan for a blank cell). Forming a blank cell forward in the movement direction of the target shelf to be moved allows the target shelf to be moved to a next cell. If a plurality of blank cells are assigned to one carry-out group, all or some of the plurality of blank cells may be used. For example, the plan may include arranging a plurality of blank cells in the movement direction of the target shelves, and moving the target shelves of the number of the blank cells at once. In steps S103 and S104 above, the carry-out path and the shelf movement plan may be generated, for each carry-out group, so as to reduce a total time required to move all the target shelves in the exclusive region to the target region.

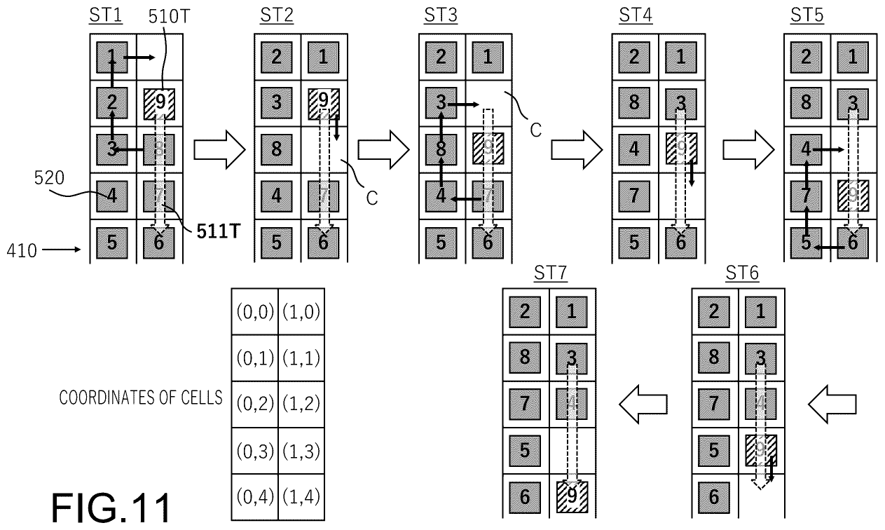

FIG. 11 shows an example of generation of a shelf movement plan. This example is different from that in FIGS. 9 and 10 for illustration. FIG. 11 shows a simplified keeping region including cells in two columns. The number in a square indicating each shelf shows a shelf ID. The bottom left shows coordinates of the cells. It is assumed that a target shelf 510T is moved along a carry-out path 511T to the carry-out region 410. As shown in a state ST1, to form a blank cell in a cell adjacent to the target shelf 510T in a movement direction of the target shelf 510T, each of the different shelves 520 is moved in directions of shown solid arrows to bring a state ST2. Since a blank cell C is formed in the cell adjacent to the target shelf 510T, the target shelf 510T is moved to the blank cell C as shown in a direction of a solid arrow. This brings a state ST3. Similarly, to form a blank cell in a cell adjacent to the target shelf 510T in the movement direction, each of the different shelves 520 is moved in directions of solid arrows to bring a state ST4. Since a blank cell C is formed in the cell adjacent to the target shelf 510T, the target shelf 510T is moved to the blank cell C as shown in a direction of a solid arrow. This brings a state ST5. Further similarly, to form a blank cell in a cell adjacent to the target shelf 510T in the movement direction, each of the different shelves 520 is moved in directions of solid arrows to bring a state ST6. Since a blank cell C is formed in the cell adjacent to the target shelf 510T, the target shelf 510T is moved to the blank cell C as shown in a direction of an arrow. This brings a state ST7, and the target shelf 510T reaches the carry-out region 410 (target region). In this way, the plan is generated to move the target shelf 510T to the carry-out region 410.

Examples of the shelf movement plan and the blank cell movement plan in FIG. 11 will be listed below. For illustration purposes, each cell is identified by the x coordinate and the y coordinate in the bottom left in

FIG. 11. Each cell may be identified by a cell ID.

### Example of Shelf Movement Plan

1. Move shelf 1 to (1,0).
2. Move shelf 2 to (0,0).
3. Move shelf 3 to (0,1).
4. Move shelf 8 to (0,2).
5. Move shelf 9 (target shelf 510T) to (1,2).
6. Move shelf 3 to (1,1).
7. Move shelf 8 to (0,1).
8. Move shelf 4 to (0,2).
9. Move shelf 7 to (0,3).
10. Move shelf 9 (target shelf 510T) to (1,3).
11. Move shelf 4 to (1,2).
12. Move shelf 7 to (0,2).
13. Move shelf 5 to (0,3).
14. Move shelf 6 to (0,4).
15. Move shelf 4 to (1,2).
16. Move shelf 9 (target shelf 510T) to (1,4).

### Example of Blank Cell Movement Plan

1. Form blank cell in (1,2).
2. Form blank cell in (1,3).
3. Form blank cell in (1,4).

In step S105, the mobile object operation planner 164 plans, for each carry-out group, an operation of the mobile object to implement the shelf movement plan generated by the shelf movement planner 163, and generates an operation plan (first operation plan) for the mobile object. The operation of the mobile object includes, for example, moving, lifting up and down a shelf, or rotating to change in direction. A series of actions include an operation of lifting up the shelf, a movement to a different cell while lifting up the shelf, and an operation of lifting down the shelf in the different cell, and these actions are repeated to move a target shelf to the carry-out region 410. Then, the target shelf may be further moved out of the carry-out region 410. If a plurality of mobile objects are assigned to the carry-out group, all or some of the plurality of mobile objects may be used. The plurality of mobile objects can be used and assigned with the series of actions in order if a plurality of blank cells are usable, efficiently forming a plurality of continuous blank cells.

In the example in FIG. 9, for the carry-out group including the target shelves 510A and 510B, an operation plan for the mobile object 1 is generated to move the target shelves 510A, 510B and the different shelves 520 in the exclusive region 513 in accordance with the shelf movement plan generated by the shelf movement planner 163. For the carry-out group including the target shelf 510C, an operation plan for the mobile object 2 is generated to move the target shelf 510C and the different shelves 520 in the exclusive region 513 in accordance with the shelf movement plan generated by the shelf movement planner 163.

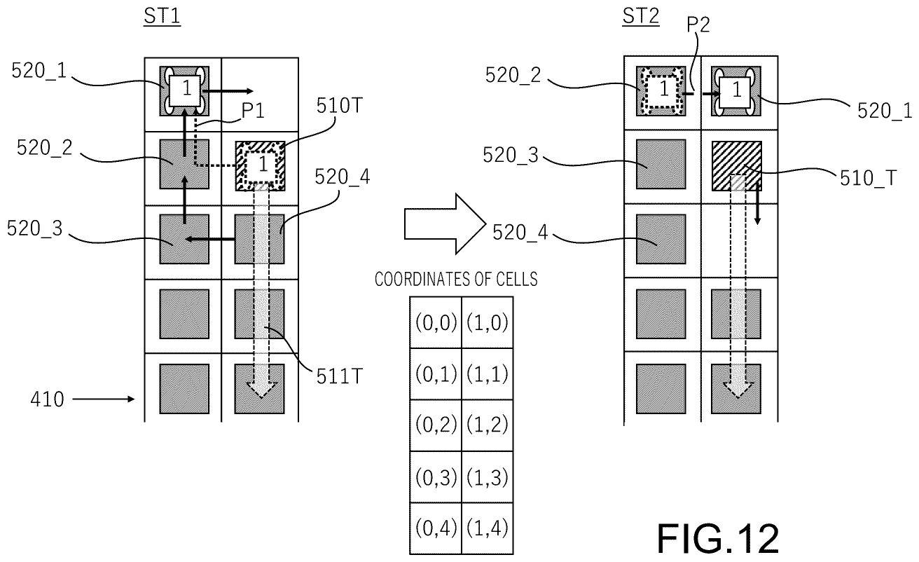

FIG. 12 shows an example of generation of an operation plan for a mobile object. Here, each of cells showing an example of a plan for an operation of the mobile object 1 when the shelves are moved, for example, from the state ST1 to the state ST2 in FIG. 11 is identified by the x coordinate and the y coordinate in the bottom middle in FIG. 12. Each cell may be identified by a cell ID.

The mobile object 1 moves from (1,1) to (0,0) (a path P1 shows a path for the mobile object 1 when moving to (0,0)) to lift up a shelf 520_1.

The mobile object 1 moves to (1,0) while lifting up the shelf 520_1, and lifts down the shelf 520_1 as shown in the state ST2 (a path P2 shows a path for the mobile object 1 when moving to (1,0).)

The mobile object 1 moves to (0,1) in the state ST1 to lift up a shelf 520_2, and then moves to (0,0) to lift down the shelf 520_2 as shown in the state ST2.

The mobile object 1 moves to (0,2) in the state ST1 to lift up a shelf 520_3, and then moves to (0,1) to lift down the shelf 520_3 as shown in the state ST2.

The mobile object 1 moves to (1,2) in the state ST1 to lift up a shelf 520_4, and then moves to (0,2) to lift down the shelf 520_4 as shown in the state ST2. Thus, a blank cell is formed in (1,2) below a target shelf 510T.

The mobile object 1 moves to (1,1) in the state ST1 to lift up the target shelf 510T, and then moves to (1,2) to lift down the target shelf 510T.

To change a movement direction, the mobile object 1 may change its direction in the movement direction.

Control instructions to perform the above operations of the mobile object 1 are generated, and the generated control instructions are arranged according to time, thereby generating an operation plan for the mobile object. For example, the following control instructions can be generated for the example in FIG. 12. The mobile object here has a function of automatically changing its direction according to its destination, and the control instructions do not include a control instruction to change in direction, but may include a control instruction to change in direction.

### Examples of Control Instructions

1. Move to (0,0).
2. Lift up the shelf 520_1.
3. Move to (1,0).
4. Lift down the shelf 520_1.
5. Move to (0,1).
6. Lift up the shelf 520_2.
7. Move to (0,0).
8. Lift down the shelf 520_2.
9. Move to (0,2).
10. Lift up the shelf 520_3.
11. Move to (0,1).
12. Lift down the shelf 520_3.
13. Move to (1,2).
14. Lift up the shelf 520_4.
15. Move to (0,2).
16. Lift down the shelf 520_4.
17. Move to (1,1).
18. Lift up the target shelf 510T.
19. Move to (1,2)
20. Lift down the target shelf 510T.

The plan processor 160 stores, in the mobile object operation storage 140, data on operation plans for the mobile objects 340 (the mobile object 1, the mobile object 2) generated by the mobile object operation planner 164.

The commander 170 reads, from the mobile object operation storage 140, the data on the operation plans for the mobile object 1 and the mobile object 2, and generates control instructions to control the operations of the mobile object 1 and the mobile object 2. The commander 170 transmits the generated control instructions to the mobile object 1 and the mobile object 2. This causes the mobile object 1 and the mobile object 2 to perform the operations indicated by the respective operation plans. The mobile object 1 and the mobile object 2 operate in accordance with the respective control instructions. Specifically, each of the mobile object 1 and the mobile object 2 moves each shelf in an assigned exclusive region, and moves the target shelf to the carry-out region 410. Then, the mobile object 1 and the mobile object 2 may each lift down the target shelf in the carry-out region 410, or move the target shelf to an outside predetermined position. In this case, the operation plan for the mobile object may include a control instruction to move the target shelf to the predetermined position.

As described above, according to the present embodiment, the plurality of target shelves are divided into a plurality of carry-out groups, an exclusive region is assigned to each carry-out group, and the target shelf is moved to the carry-out region in the exclusive region independently for each carry-out group. This prevents collision between the mobile objects or interference between the shelves when the shelves are moved in the exclusive regions, and thus the plurality of target shelves can be simultaneously efficiently moved. This can reduce time required to complete movement of all the target shelves.

### Other Example of Operation

When there are a plurality of target shelves in the exclusive region, the target shelves may be joined partway through carry-out, and then moved together. Carry-out paths for the plurality of target shelves are merged partway into one path. The plurality of target shelves are joined at a point where the paths are merged (joined point). The joining means that a plurality of target shelves are located in two or more cells adjacent to each other in the movement direction. After joining, the plurality of target shelves are moved along the same path while being kept adjacent to each other. Being kept adjacent to each other means that no other shelf is placed between the target shelves (a blank cell may be temporarily placed). A target shelf having reached the carry-out region 410 earlier may be moved out of the carry-out region 410, and then a subsequent target shelf may be also moved to and then out of the carry-out region 410. Any number of target shelves, for example, three or four target shelves may be joined.

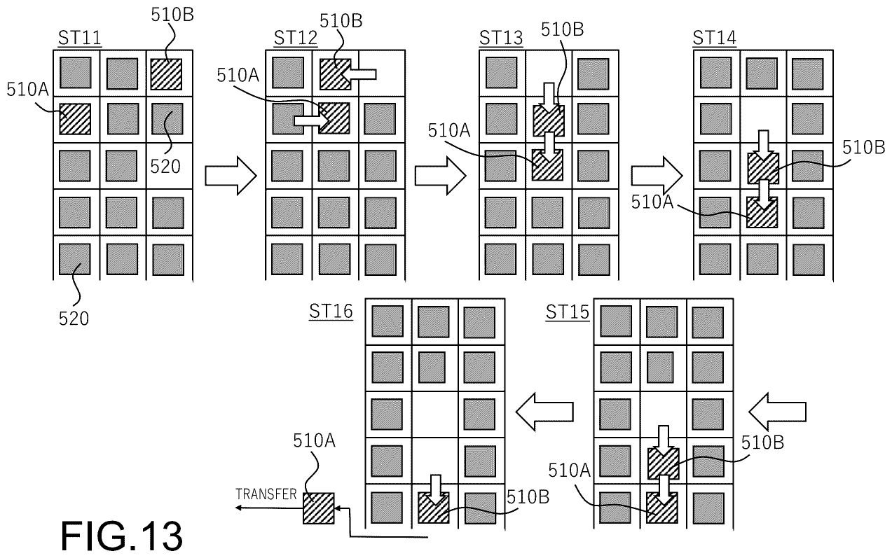

FIG. 13 shows an example of generation of a shelf movement plan to join two target shelves partway and move the target shelves while being kept adjacent to each other. The exclusive region 513 on the right in FIG. 9 is taken out and shown in a state ST11. Target shelves 510A, 510B are joined and located in adjacent cells in the same column to bring a state ST12. As shown in states ST13, ST14, ST15, a blank cell is formed in a movement direction (downward direction) of the target shelves 510A, 510B, and the target shelves 510A, 510B are moved along the same path while being kept adjacent to each other. As shown in a state ST16, the mobile object moves the target shelf 510A having reached the carry-out region 410 earlier to a predetermined location (for example, a location of a user who picks up the target shelf 510A) outside the carry-out region 410. Then, the mobile object returns, and moves the target shelf 510B to the carry-out region 410 as shown in the state ST16. Then, the target shelf 510B may be also taken out of the carry-out region 410 and moved to a predetermined location.

As described above, the plurality of target shelves are joined partway through carry-out, and then moved to the carry-out region 410 while being kept adjacent to each other. This allows the target shelves to be moved to the carry-out region 410 more efficiently or in a shorter time than when being separately moved in order.

### Variant 1

In the above first embodiment, the carry-out region 410 is provided in a lower edge of the keeping region, but may be provided in a different edge such as an upper edge, a right edge, or a left edge. The carry-out regions may be provided in two or more edges. The carry-out region may be provided inside an edge rather than in the edge of the keeping region. For example, if an elevator connecting to an upper or lower floor of the keeping region is provided in a middle of the keeping region, a carry-out region may be provided in a position facing the elevator.

### Variant 2

In the above first embodiment, the operation plan for the mobile object is generated based on the shelf movement plan and is implemented by the mobile object to implement the shelf movement plan. However, the shelf movement plan may be implemented by an operator. In this case, the shelf movement plan may be transmitted to a terminal that can be operated by the operator such that the operator can check the shelf movement plan. Also, the keeping region may include a passage between the cells through which the operator can move such that the operator can move to any cell through the passage. For example, the operator pushes a shelf in the cell to move the shelf to a next cell. A plurality of operators may simultaneously move shelves in the exclusive region in accordance with the shelf movement plan, thereby allowing target shelves to be efficiently moved to the carry-out region 410.

### Second Embodiment

In the above first embodiment, the number of carry-out groups generated by the carry-out group setter 161 is equal to the number of blank cells and the number of usable mobile objects in the keeping region. In the second embodiment, one or both of the number of blank cells and the number of mobile objects are smaller than the number of carry-out groups (the number of carry-out groups is larger than one or both of the number of blank cells and the number of mobile objects). In the second embodiment, only differences from the first embodiment will be described below.

When at least one of the number of blank cells and the number of usable mobile objects in the keeping region is smaller than the number of generated carry-out groups, the carry-out group setter 161 performs the following processes. First to third examples will be given below as examples of the processes.

As the first example, two or more carry-out groups are integrated such that the number of carry-out groups is equal to or smaller than a smaller one of the number of blank cells and the number of mobile objects. Thus, the number of carry-out groups is adjusted such that the number of groups is equal to or smaller than the number of mobile objects usable in the keeping region (process of adjusting the number of carry-out groups).

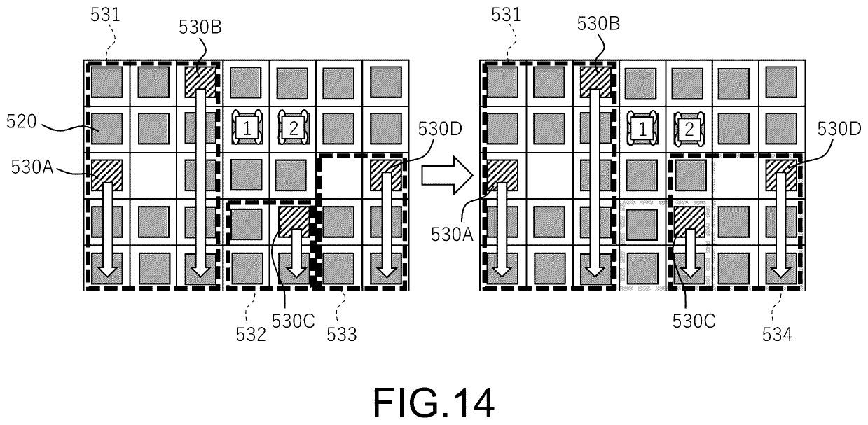

FIG. 14 shows an example of integration of two carry-out groups. As shown on the left, there are three carry-out groups: a first carry-out group including target shelves 530A, 530B, a second carry-out group including a target shelf 530C, and a third carry-out group including a target shelf 530D. An exclusive region in the first carry-out group is an exclusive region 531, an exclusive region in the second carry-out group is an exclusive region 532, and an exclusive region in the third carry-out group is an exclusive region 533. There are two blank cells in a keeping region, and usable mobile objects are a mobile object 1 and a mobile object 2. In this case, as shown on the right, the second carry-out group and the third carry-out group are integrated into one carry-out group, and the exclusive regions 532, 533 are integrated into an exclusive region 534. In this example, in the integration, the leftmost column (the leftmost column in the exclusive region 532) in a region obtained by taking a logical sum of the exclusive regions 532, 533 is removed to minimize the region, but the region obtained by taking the logical sum of the exclusive regions 532, 533 may be used.

As the second example, one or more blank cells are commonly assigned or one or more mobile objects are commonly assigned to the plurality of carry-out groups (process of commonalizing blank cell and mobile object).

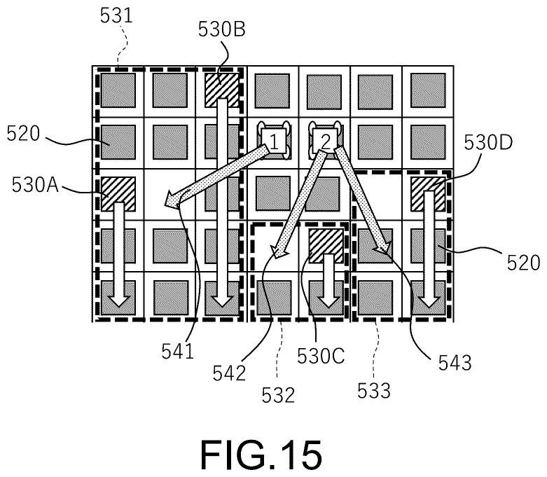

FIG. 15 shows an example of the mobile object being commonly assigned to the plurality of carry-out groups. The mobile object 1 is assigned to the first carry-out group including the target shelves 530A, 530B (541), and the mobile object 2 is commonly assigned to two carry-out groups: the second carry-out group including the target shelf 530C and the third carry-out group including the target shelf 530D (542, 543). When the mobile object is commonly assigned to the plurality of carry-out groups, the mobile object is used to move between the plurality of carry-out groups. The mobile object 2 implements, for example, an operation plan for one of the second carry-out group and the third carry-out group, and then implements an operation plan for the other carry-out group. In other words, the plan processor 160 determines to implement the operation plans in an order of the one carry-out group and the other carry-out group.

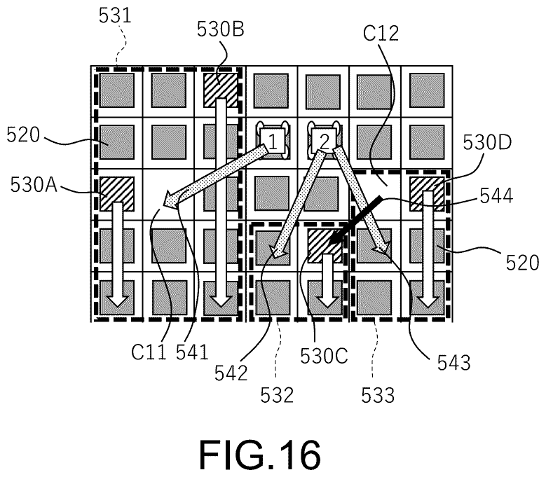

FIG. 16 shows an example of the mobile object and the blank cell being commonly assigned to the plurality of carry-out groups. The mobile object 1 is assigned to the first carry-out group including the target shelves 530A, 530B (541), and the mobile object 2 is commonly assigned to two carry-out groups: the second carry-out group including the target shelf 530C and the third carry-out group including the target shelf 530D (542, 543). Further, a blank cell C12 is commonly assigned to the second carry-out group and the third carry-out group (544). A blank cell C11 is assigned to the first carry-out group. When the blank cell is commonly assigned to the plurality of carry-out groups, the shelf 520 may be moved between the plurality of carry-out groups. For example, after the operation plan for the third carry-out group is finished, the shelf 520 may be moved from the exclusive region 532 to the exclusive region 533 to form a blank cell in the exclusive region 532. In other words, the shelf movement plan (first shelf movement plan) for the second carry-out group includes moving the shelf in the exclusive region 532 out of the exclusive region 532 to add a blank cell in the exclusive region 532. Adding the blank cell may include moving a blank cell in the exclusive region 533 to the exclusive region 532. The plan to add the blank cell corresponds to a second shelf movement plan (blank cell movement plan). The second shelf movement plan may be generated based on an arrangement state of the shelves in the exclusive region 533 or an arrangement state of the shelves in the keeping region after the operation plan for the third carry-out group is implemented. In this case, the operation plan for the third carry-out group and the operation plan for the second carry-out group are implemented in this order. If there is a blank cell that does not belong to any exclusive region, or there is an extra blank cell in the exclusive region 533, a process according to a fifth embodiment described below may be performed.

As a third example, a blank cell or a mobile object in a keeping region different from a keeping region for planning is used (process of borrowing blank cell and mobile object).

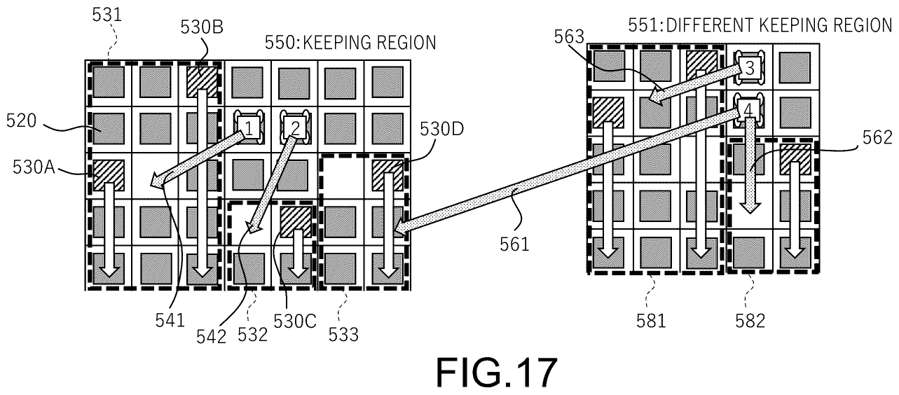

FIG. 17 shows an example of a mobile object in a different keeping region 551 being used in a keeping region 550. In the different keeping region 551, a mobile object 3 and a mobile object 4 are usable, and the mobile object 4 of the mobile objects is additionally used in the keeping region 550 in this example. In the different keeping region 551, there are two carry-out groups including respective exclusive regions 581, 582. The mobile object 3 and the mobile object 4 are assigned to the two carry-out groups, respectively (562, 563). The mobile object 4 is also assigned to a carry-out group including a target shelf 530D in the keeping region 550 (561). Specifically, the mobile object 4 is used in both of the keeping regions 550, 551. When the mobile object is assigned to the plurality of keeping regions, the mobile object may be used to move between the plurality of keeping regions. The mobile object 4 may implement an operation plan in the different keeping region 551, and then move to the keeping region 550. Using the mobile object 4 in the different keeping region 551 allows an operation plan in the exclusive region 533 to be implemented early when the operation plans in the exclusive regions 531, 532 in the keeping region 550 have not been completed.

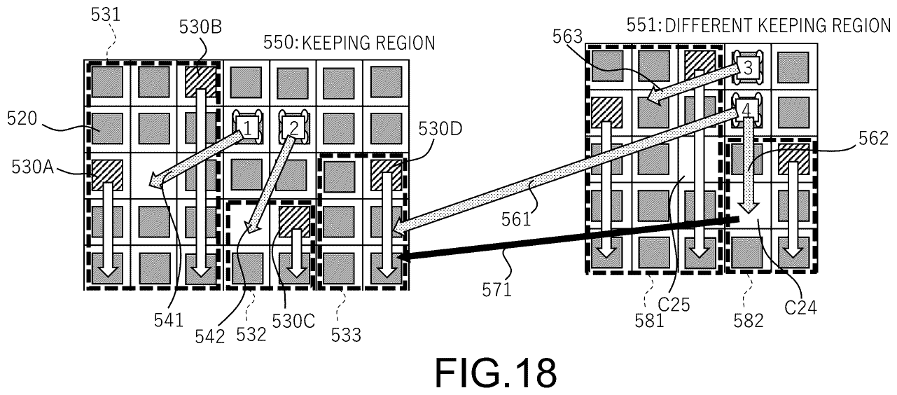

FIG. 18 shows an example of a mobile object in the different keeping region 551 being used in the keeping region 550 as in the example in FIG. 17 and further a blank cell in the different keeping region 551 being used in the keeping region 550. In the different keeping region 551, blank cells C24, C25 are usable, and the blank cell C24 of the blank cells is used in the keeping region 550 in this example. In the different keeping region 551, there are two carry-out groups, and the blank cells C24, C25 are assigned to the two carry-out groups, respectively. The blank cell C24 is also assigned to a carry-out group including the target shelf 530D in the keeping region 550 (571). When the blank cell C24 is assigned to the plurality of keeping regions, the shelf 520 may be moved from the exclusive region 533 in the keeping region 550 to the exclusive region 582 in the different keeping region 551 to form a blank cell in the exclusive region 533. The shelf 520 may be moved from a region other than the exclusive region 533 in the keeping region 550. In this case, the shelf 520 in the exclusive region 533 is moved to a different region in the keeping region 550. The blank cell is formed (added) in the exclusive region 533 after an operation plan in the exclusive region 582 in the different keeping region 551 is implemented. The blank cell may be formed by the mobile object for the carry-out group in the exclusive region 533. Using the blank cell in the different keeping region 551 allows an operation plan in the exclusive region 533 to be implemented early when the operation plans in the exclusive regions 531, 532 in the keeping region 550 have not been completed.

Two or three processes among the processes in the above first to third examples may be simultaneously implemented.

In each of the processes in the first to third examples, a criterion may be established and the process may be performed to meet the criterion. The criterion may be established based on the number of target shelves in the carry-out group, a priority of carry-out of a target shelf, a length of a carry-out path for a target shelf, a distance between the carry-out groups, or the like.

For example, in the process in the above first example, if a target shelf with a high priority is determined among the target shelves, a carry-out group including the target shelf with a high priority may be excluded from integration of carry-out groups such that the target shelves in the carry-out group including the target shelf with a high priority can be quickly carried out. A carry-out group including a target shelf with a long carry-out path may be similarly excluded from integration. The carry-out groups excluded from integration are not limited to the carry-out groups including the target shelf with a high priority or the target shelf with a long carry-out path, but a carry-out group excluded from integration may be determined based on other conditions.

Carry-out groups having a short distance between them (that is, carry-out groups having a short distance between exclusive regions) may be integrated. Alternatively, carry-out groups may be integrated so as to minimize or reduce variations in average of priorities of the target shelves among the carry-out groups after integration.

In the process in the above second example, when the plurality of blank cells or the plurality of mobile objects are commonly assigned to the plurality of carry-out groups, at least one blank cell or at least one mobile object may be exclusively assigned to a target shelf with a high priority. The same applies to a target shelf with a long carry-out path.

In the process in the above third example, when there are a plurality of different keeping regions, a keeping region from which a mobile object or a blank cell is borrowed may be a keeping region closest to a keeping region for planning. A keeping region may be also used in which at least one of the number of blank cells and the number of mobile objects is larger than the number of carry-out groups.

As described above, according to the present embodiment, even if at least one of the number of blank cells and the number of mobile objects is smaller than the number of carry-out groups, the number of carry-out groups can be adjusted to efficiently move the plurality of target shelves to the carry-out region. In addition, a blank cell or a mobile object can be used in a plurality of carry-out groups, or a blank cell or a mobile object can be borrowed from a different keeping region, thereby efficiently moving the plurality of target shelves to the carry-out region.

### Third Embodiment

A third embodiment provides a case where at least one of the number of blank cells and the number of mobile objects is larger than the number of carry-out groups. Only differences from the first embodiment will be described below.

The carry-out group setter 161 assigns a plurality of blank cells or a plurality of mobile objects to at least one carry-out group when the number of generated carry-out groups is larger than at least one of the number of blank cells and the number of mobile objects. Alternatively, the carry-out group setter 161 assigns a plurality of blank cells and a plurality of mobile objects to at least one carry-out group.

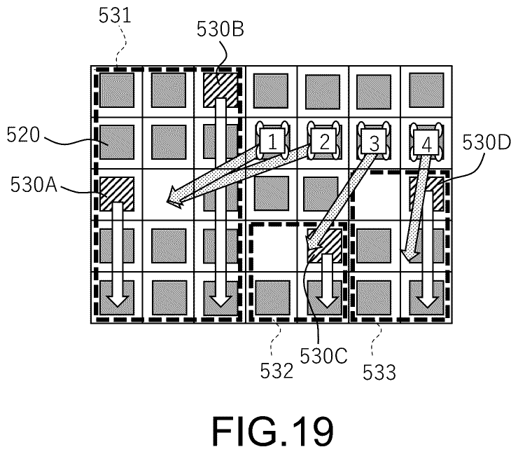

FIG. 19 shows an example of a plurality of mobile objects being assigned to one carry-out group when the number of mobile objects is larger than the number of carry-out groups. The mobile objects 1 to 4 are usable, and the mobile object 1 and the mobile object 2 are assigned to a first carry-out group including the target shelves 530A, 530B. The mobile object 3 is assigned to a second carry-out group including the target shelf 530C, and the mobile object 4 is assigned to a third carry-out group including the target shelf 530D. Similarly, when the number of blank cells is larger than the number of carry-out groups, the plurality of blank cells may be assigned to one carry-out group. In assignment of the blank cells and the mobile objects, the same criteria as those described in the second embodiment may be used. For example, a plurality of blank cells, a plurality of mobile objects, or a plurality of blank cells and a plurality of mobile objects may be assigned to a carry-out group including a target shelf with a high priority. It is not necessary to use all of the blank cells and mobile objects, but there may be some blank cells or mobile objects that are not assigned to a carry-out group.

As described above, according to the present embodiment, a plurality of blank cells, a plurality of mobile objects, or a plurality of blank cells and a plurality of mobile objects are assigned to a carry-out group, thereby allowing one or more target shelves in the carry-out group to be moved to a carry-out region in a shorter time.

### Fourth Embodiment

In the second embodiment, the process for the case where the generated carry-out group includes no blank cell or insufficient blank cells in the exclusive region. In a fourth embodiment, a further process for this case will be described. In the second embodiment, the process for the carry-out group including no blank cell is waited until the process for the other carry-out groups are completed. In the fourth embodiment, when there is an extra (unused) blank cell, the blank cell is moved to the exclusive region previously (before calculation of a carry-out path).

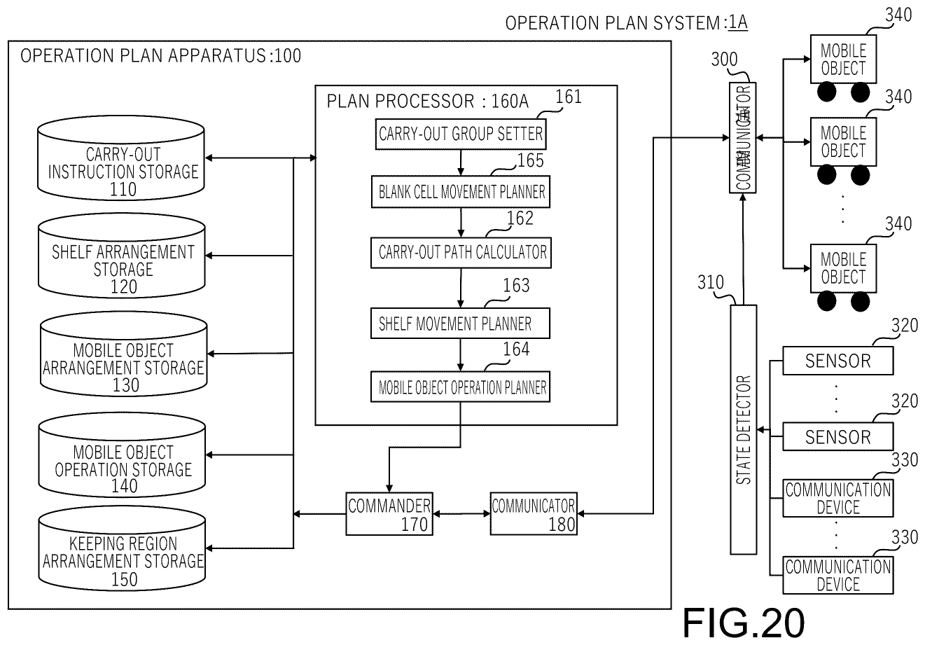

FIG. 20 is a block diagram of an operation plan system 1A according to the fourth embodiment. A blank cell movement planner 165 is added to a plan processor 160A. Other components are the same as in the first embodiment, and thus denoted by the same reference numerals, and detailed descriptions thereof will be omitted.

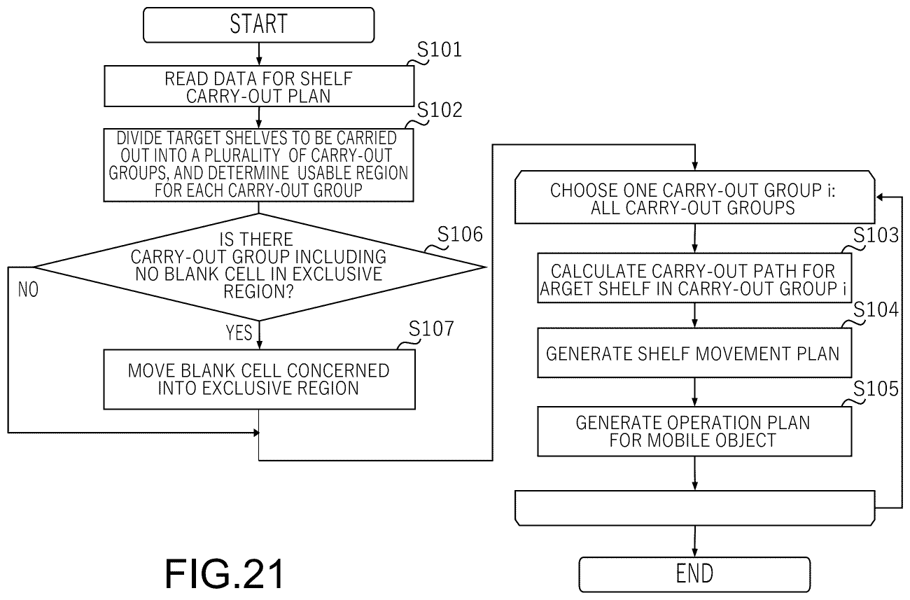

FIG. 21 is a flowchart of an example of an operation of the plan processor 160A in FIG. 20. Step S106 of performing a process by the blank cell movement planner 165 is added immediately after step S102 in the flowchart of the operation in the first embodiment (see FIG. 8).

The blank cell movement planner 165 checks if there is a carry-out group including no blank cell in the exclusive region (or a carry-out group including insufficient blank cells as compared to a desired value) among a plurality of carry-out groups generated by the carry-out group setter 161 (S106). If there is such a carry-out group (YES in S106), a shelf movement plan (blank cell movement plan or second shelf movement plan) is generated to form (add) a blank cell in the exclusive region (S107). In other words, the blank cell movement plan may be a plan to move a blank cell in a region outside the exclusive region into the exclusive region. The outside region may be a region that does not belong to any exclusive region or may be a different exclusive region (for example, when there are a plurality of blank cells in the different exclusive region). After the blank cell movement plan is generated, the carry-out path calculator 162 calculates a carry-out path for a target shelf based on an arrangement state of shelves after the blank cell movement plan ensures the blank cell in the exclusive region (S103). The shelf movement planner 163 generates a shelf movement plan for each carry-out group (S104). The mobile object operation planner 164 generates an operation plan for the mobile object such that the blank cell movement plan is implemented earlier than the shelf movement plan (first shelf movement plan) for each carry-out group (S105). A method for generating the operation plan for the mobile object relative to the blank cell movement plan may be the same as the method for generating the operation plan for the mobile object relative to the shelf movement plan in the first embodiment.

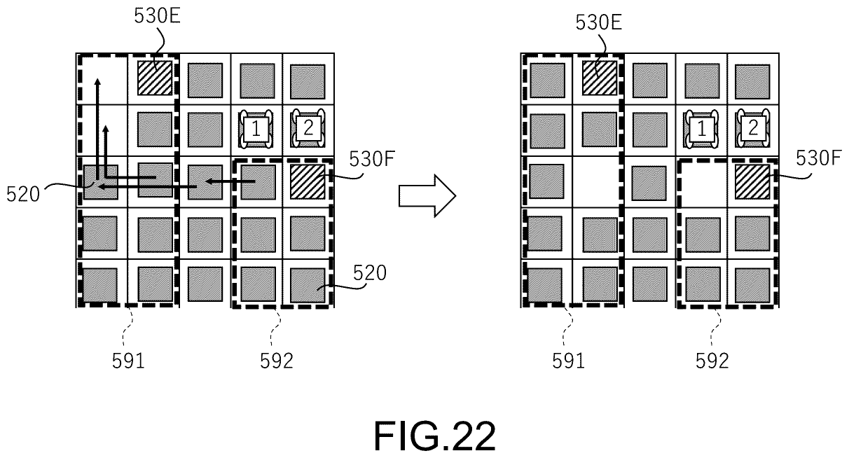

FIG. 22 shows an example of generation of the blank cell movement plan. A first carry-out group including a target shelf 530E includes two blank cells in an exclusive region 591, while a second carry-out group including a target shelf 530F includes no blank cell in an exclusive region 592. A plan is generated to move one of the two blank cells in the exclusive region 591 to the exclusive region 592. Specifically, as shown by arrows on the left, a plan to move four other shelves 520 is generated.

This plan can be implemented to ensure (add) a blank cell in the exclusive region 592 as shown on the right.

When a plurality of blank cells are ensured in the exclusive region, a plan to move blank cells in parallel using a plurality of mobile objects may be generated as long as paths can be ensured through which the blank cells are moved without interfering with each other (as long as an exclusive region including two cells in the movement direction can be ensured). The plurality of mobile objects used in this case may include mobile objects assigned to the carry-out groups concerned, and also mobile objects assigned to other carry-out groups. If the paths cannot be ensured through which the blank cells are moved without interfering with each other, a plan may be generated to move the blank cells in order, or a plan may be generated to move the blank cells in parallel while adjusting timing to move the blank cells so as not to interfere with each other.

### Other Example of Operation

After the blank cell movement planner 165 generates the blank cell movement plan, the blank cell movement plan is actually implemented to actually ensure (add) a blank cell in the exclusive region in the carry-out group, and then the process of the carry-out path calculator 162 may be performed. In this case, the mobile object operation planner 164 generates, based on the blank cell movement plan, an operation plan for the mobile object (second operation plan) to implement the blank cell movement plan, causing the commander 170 to implement the generated operation plan. The commander 170 controls the one or more mobile objects 340 in accordance with the operation plan, and ensures a blank cell in the exclusive region concerned. Then, the commander 170 notifies completion of implementation of the operation plan to the carry-out path calculator 162, and the carry-out path calculator 162 starts the process. The mobile object 340 used to ensure the blank cell may be any one or more mobile objects 340.

### Fifth Embodiment

In the above fourth embodiment, when the blank cell movement plan is generated to move a blank cell from a different region to an exclusive region including insufficient blank cells, the blank cell is moved into the exclusive region and thus a target shelf in the exclusive region may be moved out of the exclusive region. A fifth embodiment addresses this case. Only differences from the fourth embodiment will be described below.

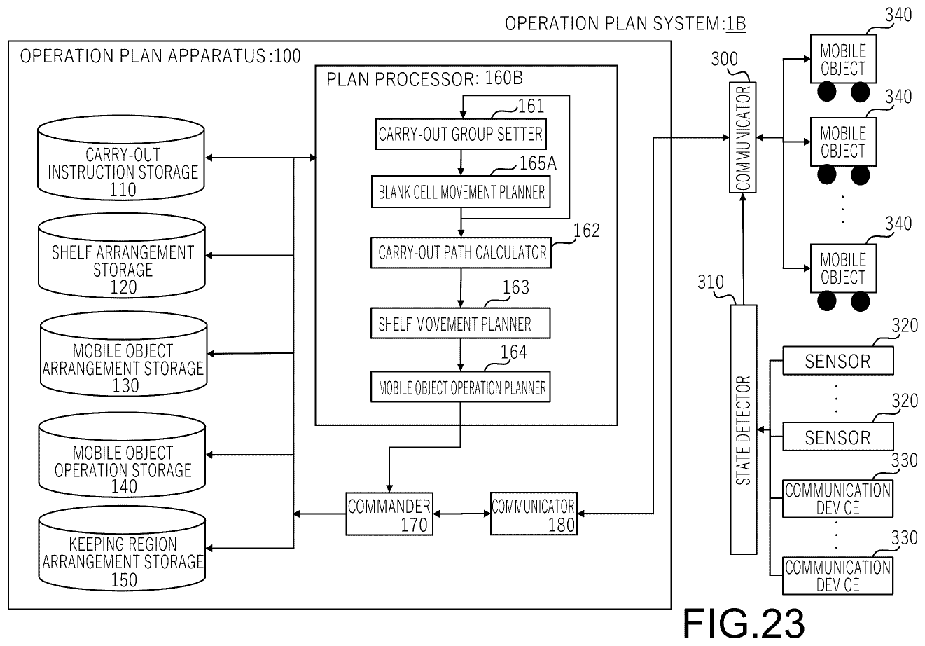

FIG. 23 is a block diagram of an operation plan system 1B according to the fifth embodiment. A blank cell movement planner 165A is added to a plan processor 160B. The blank cell movement planner 165A works basically the same as the blank cell movement planner 165 in the fourth embodiment, but some processes are expanded. Other components are the same as in the fourth embodiment, and thus denoted by the same reference numerals, and detailed descriptions thereof will be omitted.

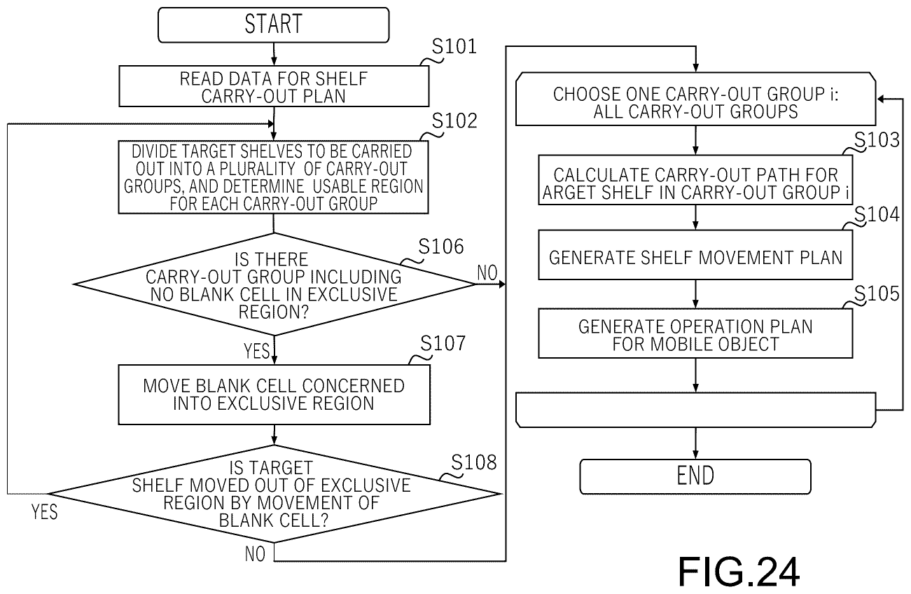

FIG. 24 is a flowchart of an example of an operation of the plan processor 160 B in FIG. 23. Step S108 of a determination process by the blank cell movement planner 165A is added after step S107 in the flowchart of the operation in the fourth embodiment (see FIG. 21).

When the blank cell movement planner 165A generates a blank cell movement plan, the blank cell movement planner 165A checks, in the generated plan, whether or not a target shelf included in an exclusive region in a carry-out group can be moved out of the exclusive region by movement of the blank cell to the exclusive region (S108). If the target shelf cannot be moved out of the exclusive region (NO in S108), the process proceeds to step S103. If the target shelf can be moved out of the exclusive region (YES in S108), the carry-out group setter 161 again performs processes of setting a carry-out group and setting an exclusive region, or the like (S102), and all the target shelves are included in any of a plurality of carry-out groups. Then, the process of the blank cell movement planner 165A is again performed, and if the assigned blank cell is within the exclusive region (NO in S106), the process proceeds to step S103. If there is an assigned blank cell outside the exclusive region (YES in S106), the blank cell movement plan is generated as described above (S107). When the blank cell is moved to the exclusive region in the carry-out group, it is determined whether or not the target shelf included in the exclusive region can be moved out of the exclusive region (S108).

The mobile object operation planner 164 generates an operation plan for the mobile object such that all the blank cell movement plans generated by the blank cell movement planner 165A are implemented in order of generation.

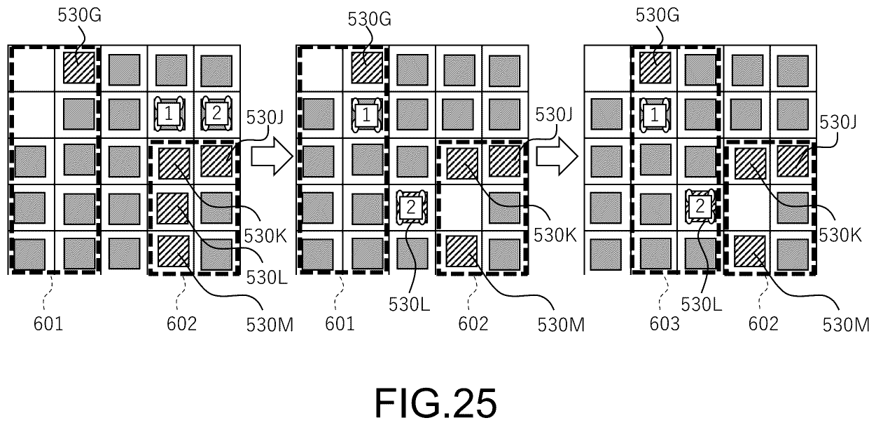

FIG. 25 shows an example of a target shelf being moved out of the exclusive region in the carry-out group to again perform a process of setting a carry-out group. As shown on the left, a first carry-out group including a target shelf 530G includes two blank cells in an exclusive region 601. On the other hand, a second carry-out group including target shelves 530J, 530K, 530L, 530M includes no blank cell in an exclusive region 602. As shown on the middle, a plan (blank cell movement plan) is generated to move one of the two blank cells in the exclusive region 601 in the first carry-out group to the exclusive region 602. This plan ensures a blank cell in the exclusive region 602, but the target shelf 530L is moved out of the exclusive region 602. Based on this plan, a process of setting a carry-out group is again performed to newly set a first carry-out group including the target shelve 530G, 530L as shown on the right, and newly set a second carry-out group including the target shelves 530J, 530K, 530M. The new first carry-out group includes no blank cell in an exclusive region 603, and thus the blank cell movement planner 165A generates a plan to ensure a blank cell (blank cell movement plan). Thereafter, this procedure is repeated until a target shelf is no longer moved out of the exclusive region in the carry-out group.

### Other Example of Operation

As in the other example of operation in the fourth embodiment, every time the blank cell movement planner 165A generates a blank cell movement plan, the blank cell movement plan may be actually implemented to actually ensure a blank cell in the exclusive region in the carry-out group. In this case, the mobile object operation planner 164 generates an operation plan (second operation plan) for the mobile object to implement the blank cell movement plan every time the blank cell movement plan is generated, and causes the commander 170 to implement the generated operation plan. The commander 170 controls the one or more mobile objects 340 in accordance with the operation plan, and ensures a blank cell in the exclusive region in the carry-out group.

### Hardware Configuration

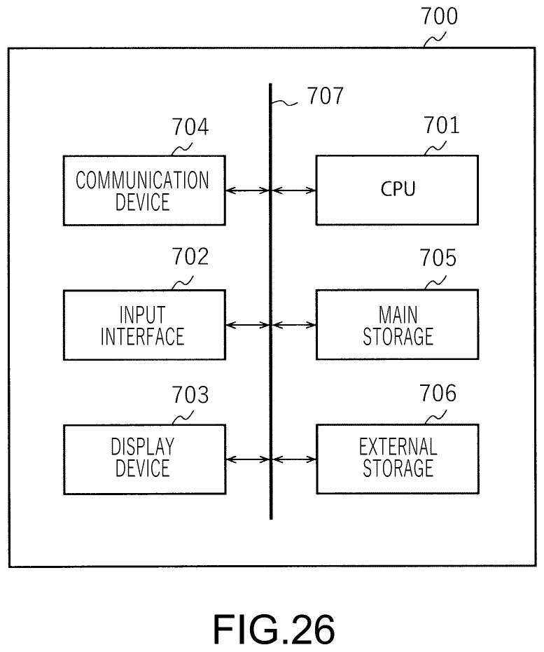

FIG. 26 illustrates a hardware configuration of the information processing apparatus 700 as an operation plan apparatus according to each embodiment. The information processing apparatus is configured as a computer device 700. The computer device 700 includes a CPU 701, an input interface 702, a display device 703, a communication device 704, a main storage device 705, and an external storage device 706, and these components are mutually connected through a bus 707.

The CPU (central processing unit) 701 executes an information processing program as a computer program on the main storage device 705. The information processing program is a computer program configured to achieve each above-described functional composition of the present device. The information processing program may be achieved by a combination of a plurality of computer programs and scripts instead of one computer program. Each functional composition is achieved as the CPU 701 executes the information processing program.

The input interface 702 is a circuit for inputting to the present information processing device, an operation signal from an input device such as a keyboard, a mouse, or a touch panel.

The display device 703 displays data output from the present device. The display device 703 is, for example, a liquid crystal display (LCD), an organic electroluminescence display, a cathode-ray tube (CRT), or a plasma display (PDP) but is not limited thereto. Data output from the computer device 700 can be displayed on the display device 703.

The communication device 704 is a circuit for the present device to communicate with an external device in a wireless or wired manner. Data can be input from the external device through the communication device 704. The data input from the external device can be stored in the main storage device 705 or the external storage device 706. The communication device 704 corresponds to the communicator 180.

The main storage device 705 stores, for example, the information processing program, data necessary for execution of the information processing program, and data generated through execution of the information processing program. The information processing program is loaded and executed on the main storage device 705. The main storage device 705 is, for example, a RAM, a DRAM, or an SRAM but is not limited thereto. Each storage or database in the information processing apparatus in each embodiment may be implemented on the main storage device 705.

The external storage device 706 stores, for example, the information processing program, data necessary for execution of the information processing program, and data generated through execution of the information processing program. The information processing program and the data are read onto the main storage device 705 at execution of the information processing program. The external storage device 706 is, for example, a hard disk, an optical disk, a flash memory, or a magnetic tape but is not limited thereto. Each storage or database in the information processing apparatus in each embodiment may be implemented on the external storage device 706.

The information processing program may be installed on the computer device 700 in advance or may be stored in a storage medium such as a CD-ROM. Moreover, the information processing program in each embodiment may be uploaded on the Internet.

The information processing apparatus may be configured as a single computer device 700 or may be configured as a system including a plurality of mutually connected computer devices 700.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments of the present invention can also be configured as follows.

### Clauses

Clause 1. An information processing apparatus comprising a processor, the processor being configured to,
   read
      information on a keeping region, the keeping region including a plurality of unit regions adjacent to each other, a shelf being able to be arranged in each of the unit regions, the shelf arranged in the unit region being movable to an empty region that is a unit region adjacent to the unit region and in which no shelf is arranged,
      information on a plurality of target shelves among the plurality of the shelves arranged in any of the unit regions in the keeping region, and
      information on a plurality of target regions that are the unit regions as destinations of the plurality of target shelves,
   divide the plurality of target shelves into a plurality of groups each including one or more of the target shelves,
   determine, for each of the groups, an exclusive region exclusively usable and including unit regions adjacent to each other, the exclusive region including the unit region in which the target shelf is arranged, the target region of the target shelf, and the empty region, and
   generate, for each of the groups, a first shelf movement plan to move a shelf different from the target shelf in the exclusive region to change a position of the empty region, thereby moving the target shelf to the target region.
Clause 2. The information processing apparatus according to claim 1, wherein the shelf is movable in the keeping region and movable by a mobile object capable of holding or releasing the shelf,
   the processor assigns one or more mobile objects to each of the groups, and
   the processor plans, for each of the groups, an operation of the mobile object to move the target shelf and the different shelf in accordance with the first shelf movement plan to generate a first operation plan for the mobile object.
Clause 3. The information processing apparatus according to claim 2, comprising a controller configured to control the mobile object to implement the first operation plan for each of the groups.
Clause 4. The information processing apparatus according to any one of claims 1 to 3, wherein the processor determines a first path through which the target shelves are moved to the target region in the keeping region, the first path being a sequence of one or more of the unit regions, and
   the processor calculates a use region including one or more of the unit regions used when the target shelves are moved along the first path, and classifies, into the same group, the target shelves in the use regions that at least partially overlap each other.
Clause 5. The information processing apparatus according to claim 4, wherein the first path is a path along which the target shelves are movable to the target region in a shortest distance.
Clause 6. The information processing apparatus according to according to any one of claims 1 to 5, wherein the processor determines, for each of the groups, a second path along which the target shelves are moved to the target region in the exclusive region, the second path being a sequence of one or more of the unit regions, and
   the processor generates the first shelf movement plan to move the target shelves along the determined second path.
Clause 7. The information processing apparatus according to claim 6, wherein the second path is a path along which the target shelves is movable to the target region in a shortest distance.
Clause 8. The information processing apparatus according to claim 6 or 7, wherein the first shelf movement plan includes repeating moving the different shelf in the exclusive region to form the empty region adjacent to the unit region including the target shelf in a movement direction of the target shelf along the second path, and moving the target shelf to the formed empty region, until the target shelf reaches the target region.
Clause 9. The information processing apparatus according to according to any one of claims 6 to 8, wherein when the group includes two or more target shelves, the processor determines the second paths for the two or more target shelves such that the two or more target shelves are merged partway through the second paths, and
   the processor generates the first shelf movement plan to join the two or more target shelves at a point where the second paths are merged, and move the joined two or more target shelves while being kept adjacent to each other.
Clause 10. The information processing apparatus according to according to any one of claims 1 to 9, wherein the processor generates, for each of the groups, the first shelf movement plan so as to reduce a total time required to move all the target shelves in the exclusive region to the target region.
Clause 11. The information processing apparatus according to according to any one of claims 2 to 10, wherein the processor divides the target shelves into the plurality of groups and assigns one or more of the mobile objects to the plurality of groups based on information on the mobile object so as to reduce a maximum time required to move all the target shelves in the plurality of groups to the target region.
Clause 12. The information processing apparatus according to any one of claims 2 to 10, wherein the processor sets the number of groups into which the plurality of target shelves are divided to the number of mobile objects usable in the keeping region or smaller.
Clause 13. The information processing apparatus according to any one of claims 3 to 10, wherein when the number of the plurality of groups is larger than the number of mobile objects usable in the keeping region, the processor determines an order of the groups for which the first shelf movement plan is implemented and the mobile objects to be assigned to the groups, and
   the controller implements the first operation plan based on the first shelf movement plan in the determined order of the groups.
Clause 14. The information processing apparatus according to any one of claims 1 to 13, wherein the processor sets the number of groups into which the plurality of target shelves are divided to the number of the empty regions in the keeping region or smaller.
Clause 15. The information processing apparatus according to any one of claims 1 to 14, wherein the processor generates the exclusive region that does not include the empty region or includes an insufficient number of the empty regions, and
   the processor generates a second shelf movement plan to move the different shelf in the exclusive region out of the exclusive region to add the empty region in the exclusive region.
Clause 16. The information processing apparatus according to claim 15, wherein the processor generates the first shelf movement plan based on an arrangement of the shelves in the keeping region after the empty region is added by the second shelf movement plan.
Clause 17. The information processing apparatus according to claim 15 or 16, wherein the processor plans an operation of the mobile object to move the different shelf out of the exclusive region based on the second shelf movement plan to generate a second operation plan for the mobile object,
   the information processing apparatus comprises a controller configured to control the mobile object to implement the second operation plan, and
   the processor generates the first shelf movement plan after the second operation plan is implemented to form the empty region in the exclusive region.
Clause 18. The information processing apparatus according to any one of claims 15 to 17, wherein moving the shelf out of the exclusive region includes moving the shelf in the keeping region to a different keeping region.
Clause 19. The information processing apparatus according to any one of claims 2 to 18, wherein the plurality of unit regions are arranged in a grid of two rows and two columns or more.
Clause 20. The information processing apparatus according to any one of claims 2 to 19, wherein a space through which the mobile object is able to pass is provided between a bottom surface of each of the shelves and a floor of the keeping region,
   the mobile object moves through the space, and is thus movable between the unit regions in which the shelves are arranged, and
   the mobile object is able to lift up and down the shelf while being located in the space in the unit region in which the shelf is arranged, and move, while lifting up the shelf, to the empty region adjacent to the unit region in which the shelf is arranged.
Clause 21. An information processing method comprising:
   reading
      information on a keeping region, the keeping region including a plurality of unit regions adjacent to each other, a shelf being able to be arranged in each of the unit regions, the shelf arranged in the unit region being movable to an empty region that is a unit region adjacent to the unit region and in which no shelf is arranged,
      information on a plurality of target shelves among the plurality of the shelves arranged in any of the unit regions in the keeping region, and
      information on a plurality of target regions that are the unit regions as destinations of the plurality of target shelves,
   dividing the plurality of target shelves into a plurality of groups each including one or more of the target shelves,
   determining, for each of the groups, an exclusive region exclusively usable and including unit regions adjacent to each other, the exclusive region including the unit region in which the target shelf is arranged, the target region of the target shelf, and the empty region, and
   generating, for each of the groups, a first shelf movement plan to move a shelf different from the target shelf in the exclusive region to change a position of the empty region, thereby moving the target shelf to the target region.
Clause 22. A non-transitory computer readable medium having a computer program stored therein which causes a computer to perform processes comprising:
   reading
      information on a keeping region, the keeping region including a plurality of unit regions adjacent to each other, a shelf being able to be arranged in each of the unit regions, the shelf arranged in the unit region being movable to an empty region that is a unit region adjacent to the unit region and in which no shelf is arranged,
      information on a plurality of target shelves among the plurality of the shelves arranged in any of the unit regions in the keeping region, and
      information on a plurality of target regions that are the unit regions as destinations of the plurality of target shelves,
   dividing the plurality of target shelves into a plurality of groups each including one or more of the target shelves,
   determining, for each of the groups, an exclusive region exclusively usable and including unit regions adjacent to each other, the exclusive region including the unit region in which the target shelf is arranged, the target region of the target shelf, and the empty region, and
   generating, for each of the groups, a first shelf movement plan to move a shelf different from the target shelf in the exclusive region to change a position of the empty region, thereby moving the target shelf to the target region.
Clause 23. An information processing system comprising:
   a plurality of mobile objects movable within a keeping region, the keeping region including a plurality of unit regions adjacent to each other, a shelf being able to be arranged in each of the unit regions, the shelf arranged in the unit region being movable to an empty region that is a unit region adjacent to the unit region and in which no shelf is arranged, the shelf being movable by the mobile object capable of holding or releasing the shelf;
   a processor configured to:
      read information on the keeping region, information on a plurality of target shelves among the plurality of shelves arranged in any of the unit regions in the keeping region, and information on a plurality of target regions that are the unit regions as destinations of the plurality of target shelves,
      divide the plurality of target shelves into a plurality of groups each including one or more of the target shelves,
      determine, for each of the groups, an exclusive region exclusively usable and including unit regions adjacent to each other, the exclusive region including the unit region in which the target shelf is arranged, the target region of the target shelf, and the empty region,
      generate, for each of the groups, a first shelf movement plan to move a shelf different from the target shelf in the exclusive region to change a position of the empty region, thereby moving the target shelf to the target region, and
      generate, for each of the groups, a first operation plan of the mobile object by planning an operation of the mobile object to move the target shelf and the other shelf according to the first shelf movement plan; and
   a controller configured to execute the first operation plan by controlling the mobile object for each of the groups.

1. An information processing apparatus comprising a processor, the processor being configured to,
read
information on a keeping region, the keeping region including a plurality of unit regions adjacent to each other, a shelf being able to be arranged in each of the unit regions, the shelf arranged in the unit region being movable to an empty region that is a unit region adjacent to the unit region and in which no shelf is arranged,
information on a plurality of target shelves among the plurality of the shelves arranged in any of the unit regions in the keeping region, and
information on a plurality of target regions that are the unit regions as destinations of the plurality of target shelves,
divide the plurality of target shelves into a plurality of groups each including one or more of the target shelves,
determine, for each of the groups, an exclusive region exclusively usable and including unit regions adjacent to each other, the exclusive region including the unit region in which the target shelf is arranged, the target region of the target shelf, and the empty region, and
generate, for each of the groups, a first shelf movement plan to move a shelf different from the target shelf in the exclusive region to change a position of the empty region, thereby moving the target shelf to the target region.

2. The information processing apparatus according to claim 1, wherein the shelf is movable in the keeping region and movable by a mobile object capable of holding or releasing the shelf,
the processor assigns one or more mobile objects to each of the groups, and
the processor plans, for each of the groups, an operation of the mobile object to move the target shelf and the different shelf in accordance with the first shelf movement plan to generate a first operation plan for the mobile object.

3. The information processing apparatus according to claim 2, comprising a controller configured to control the mobile object to implement the first operation plan for each of the groups.

4. The information processing apparatus according to claim 1, wherein the processor determines a first path through which the target shelves are moved to the target region in the keeping region, the first path being a sequence of one or more of the unit regions, and
the processor calculates a use region including one or more of the unit regions used when the target shelves are moved along the first path, and classifies, into the same group, the target shelves in the use regions that at least partially overlap each other.

5. The information processing apparatus according to claim 4, wherein the first path is a path along which the target shelves are movable to the target region in a shortest distance.

6. The information processing apparatus according to claim 1, wherein the processor determines, for each of the groups, a second path along which the target shelves are moved to the target region in the exclusive region, the second path being a sequence of one or more of the unit regions, and
the processor generates the first shelf movement plan to move the target shelves along the determined second path.

7. The information processing apparatus according to claim 6, wherein the second path is a path along which the target shelves is movable to the target region in a shortest distance.

8. The information processing apparatus according to claim 6, wherein the first shelf movement plan includes repeating moving the different shelf in the exclusive region to form the empty region adjacent to the unit region including the target shelf in a movement direction of the target shelf along the second path, and moving the target shelf to the formed empty region, until the target shelf reaches the target region.

9. The information processing apparatus according to claim 6, wherein when the group includes two or more target shelves, the processor determines the second paths for the two or more target shelves such that the two or more target shelves are merged partway through the second paths, and
the processor generates the first shelf movement plan to join the two or more target shelves at a point where the second paths are merged, and move the joined two or more target shelves while being kept adjacent to each other.

10. The information processing apparatus according to claim 1, wherein the processor generates, for each of the groups, the first shelf movement plan so as to reduce a total time required to move all the target shelves in the exclusive region to the target region.

11. The information processing apparatus according to claim 2, wherein the processor divides the target shelves into the plurality of groups and assigns one or more of the mobile objects to the plurality of groups based on information on the mobile object so as to reduce a maximum time required to move all the target shelves in the plurality of groups to the target region.

12. The information processing apparatus according to claim 2, wherein the processor sets the number of groups into which the plurality of target shelves are divided to the number of mobile objects usable in the keeping region or smaller.

13. The information processing apparatus according to claim 3, wherein when the number of the plurality of groups is larger than the number of mobile objects usable in the keeping region, the processor determines an order of the groups for which the first shelf movement plan is implemented and the mobile objects to be assigned to the groups, and
the controller implements the first operation plan based on the first shelf movement plan in the determined order of the groups.

14. The information processing apparatus according to claim 1, wherein the processor sets the number of groups into which the plurality of target shelves are divided to the number of the empty regions in the keeping region or smaller.

15. The information processing apparatus according to claim 1, wherein the processor generates the exclusive region that does not include the empty region or includes an insufficient number of the empty regions, and
the processor generates a second shelf movement plan to move the different shelf in the exclusive region out of the exclusive region to add the empty region in the exclusive region.

16. The information processing apparatus according to claim 15, wherein the processor generates the first shelf movement plan based on an arrangement of the shelves in the keeping region after the empty region is added by the second shelf movement plan.

17. The information processing apparatus according to claim 15, wherein the processor plans an operation of the mobile object to move the different shelf out of the exclusive region based on the second shelf movement plan to generate a second operation plan for the mobile object,
the information processing apparatus comprises a controller configured to control the mobile object to implement the second operation plan, and
the processor generates the first shelf movement plan after the second operation plan is implemented to form the empty region in the exclusive region.

18. The information processing apparatus according to claim 15, wherein moving the shelf out of the exclusive region includes moving the shelf in the keeping region to a different keeping region.

19. The information processing apparatus according to claim 1, wherein the plurality of unit regions are arranged in a grid of two rows and two columns or more.

20. The information processing apparatus according to claim 2, wherein a space through which the mobile object is able to pass is provided between a bottom surface of each of the shelves and a floor of the keeping region,
the mobile object moves through the space, and is thus movable between the unit regions in which the shelves are arranged, and
the mobile object is able to lift up and down the shelf while being located in the space in the unit region in which the shelf is arranged, and move, while lifting up the shelf, to the empty region adjacent to the unit region in which the shelf is arranged.

21. An information processing method comprising:
reading
information on a keeping region, the keeping region including a plurality of unit regions adjacent to each other, a shelf being able to be arranged in each of the unit regions, the shelf arranged in the unit region being movable to an empty region that is a unit region adjacent to the unit region and in which no shelf is arranged,
information on a plurality of target shelves among the plurality of the shelves arranged in any of the unit regions in the keeping region, and
information on a plurality of target regions that are the unit regions as destinations of the plurality of target shelves,
dividing the plurality of target shelves into a plurality of groups each including one or more of the target shelves,
determining, for each of the groups, an exclusive region exclusively usable and including unit regions adjacent to each other, the exclusive region including the unit region in which the target shelf is arranged, the target region of the target shelf, and the empty region, and
generating, for each of the groups, a first shelf movement plan to move a shelf different from the target shelf in the exclusive region to change a position of the empty region, thereby moving the target shelf to the target region.

22. A non-transitory computer readable medium having a computer program stored therein which causes a computer to perform processes comprising:
reading
information on a keeping region, the keeping region including a plurality of unit regions adjacent to each other, a shelf being able to be arranged in each of the unit regions, the shelf arranged in the unit region being movable to an empty region that is a unit region adjacent to the unit region and in which no shelf is arranged,
information on a plurality of target shelves among the plurality of the shelves arranged in any of the unit regions in the keeping region, and
information on a plurality of target regions that are the unit regions as destinations of the plurality of target shelves,
dividing the plurality of target shelves into a plurality of groups each including one or more of the target shelves,
determining, for each of the groups, an exclusive region exclusively usable and including unit regions adjacent to each other, the exclusive region including the unit region in which the target shelf is arranged, the target region of the target shelf, and the empty region, and
generating, for each of the groups, a first shelf movement plan to move a shelf different from the target shelf in the exclusive region to change a position of the empty region, thereby moving the target shelf to the target region.

23. An information processing system comprising:
a plurality of mobile objects movable within a keeping region, the keeping region including a plurality of unit regions adjacent to each other, a shelf being able to be arranged in each of the unit regions, the shelf arranged in the unit region being movable to an empty region that is a unit region adjacent to the unit region and in which no shelf is arranged, the shelf being movable by the mobile object capable of holding or releasing the shelf;
a processor configured to:
read information on the keeping region, information on a plurality of target shelves among the plurality of shelves arranged in any of the unit regions in the keeping region, and information on a plurality of target regions that are the unit regions as destinations of the plurality of target shelves,
divide the plurality of target shelves into a plurality of groups each including one or more of the target shelves,
determine, for each of the groups, an exclusive region exclusively usable and including unit regions adjacent to each other, the exclusive region including the unit region in which the target shelf is arranged, the target region of the target shelf, and the empty region,
generate, for each of the groups, a first shelf movement plan to move a shelf different from the target shelf in the exclusive region to change a position of the empty region, thereby moving the target shelf to the target region, and
generate, for each of the groups, a first operation plan of the mobile object by planning an operation of the mobile object to move the target shelf and the other shelf according to the first shelf movement plan; and
a controller configured to execute the first operation plan by controlling the mobile object for each of the groups.
